(19) United States
(12) Patent Application Publication
(10) Pub. No.: US 2026/0307428 A1
(43) Pub. Date: Oct. 8, 2026

(54) PAINT CONTAINER LID, SYSTEM, AND METHOD OF USE

(71) Applicant: Harry Billado,, JR., Newbury, NH (US)

(72) Inventor: Harry Billado,, JR., Newbury, NH (US)

(21) Appl. No.: 19/276,896

(22) Filed: Jul. 22, 2025

Related U.S. Application Data
(60) Provisional application No. 63/783,905, filed on Apr. 4, 2025.

(51) Int. Cl. B44D 3/12

(52) U.S. Cl. CPC B44D 3/123; B44D 3/126

(57) ABSTRACT

A paint container system can include a paint container base portion and a lid portion. The lid can include a rim that can detachably secures to the container, a pull-tab, and at least one flexibly sealable aperture that can receive/secure a paint implement. The container can include a rim for receiving the lid, an internal cavity for holding paint, and a magnet at the rear for securing a paint brush within the cavity.

### RELATED APPLICATIONS

This application claims the benefit of U.S. Provisional Application Ser. No. 63/673,974, filed Jul. 22, 2024, entitled PAINT CONTAINER LID, SYSTEM, AND METHOD OF USE, and the benefit of U.S. Provisional Application Ser. No. 63/783,905, filed Apr. 4, 2025, entitled PAINT CONTAINER LID, SYSTEM, AND METHOD OF USE, the entire dis-closures of which are herein incorporated herein by reference.

### FIELD OF THE INVENTION

This application relates to containers for liquids, and more particularly, to lids for containers of paint or other coatings.

### BACKGROUND OF THE INVENTION

A paint container is the ideal painter's tool for holding paint and paint implements used for applying paint to walls, ceilings, trim, and other surfaces. Unlike a typical one gallon paint can, a hand-held paint container is designed to hold a manageable amount of paint that is readily available to the user wherever they move around the area being painted. Furthermore, many of these containers have at least one handle or flexible strap designed to more comfortably hold and secure the container. The flexible strap can be stretched to provide space for a user's hand between the rear of the container body and the strap. Some containers additionally include a flexible bail, thus giving the user multiple options for holding/securing the container. These containers can include a brush magnet for temporarily holding a paint brush within the container when the brush is not immediately being used. Some containers also include an inclined paint roller ramp with a plurality of inner surface regions projecting therefrom for evenly loading paint and for scraping paint from a roller, and can further include a ledge or slot along the front rim of the container that can hold the roller handle that secures the roller within the container when it is not being used. Some larger containers, such as one, two, or five gallon buckets can incorporate a separate inclined paint roller ramp that can have various surfaces for distributing paint on a roller, and be placed within the bucket while the user is painting. These containers can be a wise choice for holding paint and implements for actively painting walls, ceilings, trim, and other surfaces.

While these various paint containers can be very effective at painting a room, they do not provide for the option to store both the paint and any paint implements, such as a roller, brush, or incline paint roller ramp within the container for an extended period of time. A paint brush and/or paint roller used with these containers will become damaged if left to dry loaded with paint. As a result, the paint and implements used with these containers need to be washed if work is interrupted due to a lunch or coffee break, or between work days for either short or long-term storage.

There is a never ending desire to increase performance and ease-of use of painting tools like containers, while at the same time reducing or eliminating the end of day clean-up. Furthermore, there is a strong desire to save the cost of having to purchase new paint implements because they were not properly washed or stored, or simply were left to dry out. Accordingly, there exists a need for an improved paint container system that adequately provides a user with the ability to store paint within the container and optionally allow for implement storage, which can save time and money when painting.

### SUMMARY OF THE INVENTION

One possible solution to this problem is to make a lid keeping the paint from drying out within the container. However, this only solves part of the problem and does not allow for the option of implement storage within the container. Another possible solution is to make one or more small holes in the lid to allow for paint implement handles to remain outside the container while the paint applicator portion of the implement, such as bristles of a brush, and/or fabric, foam or the like of a roller, remain within the container and under the lid. However, should a user not want to store a paint implement within the container, there would remain one or more holes in the lid allowing the paint in the container to dry out.

The present description includes various lids and systems of containers with lids that can be used to seal paint within a container when the user is not actively painting. In various embodiments, the lids and systems of containers with lids can have self-sealing apertures in the lids. The self-sealing apertures can accommodate the handles of paint brushes and/or paint rollers, so that the bristles and/or roller heads can remain inside of the sealed container while the handles extend through the lid and outside of the container. This allows the handles to remain clean and/or extend outside of a container that is too small to hold the entire implement within the container, while the paint-bearing portion of the implements can be sealed within the container with the paint.

### BRIEF DESCRIPTION OF THE DRAWINGS

Reference is made to the accompanying drawings in which particular embodiments and further benefits of the provided subject matter are illustrated as described in more de-tail in the description below.

FIG. 1 is a perspective view of an exemplary container with a flexible strap opposite an inclined roller ramp, according to an illustrative embodiment;

FIG. 2 is a right side view of the container of FIG. 1, according to an illustrative embodiment;

FIG. 3 is a top view of the container of FIG. 1, according to an illustrative embodiment;

FIG. 4 is a rear perspective view of another exemplary container with a flexible strap opposite an inclined roller ramp, according to an illustrative embodiment;

FIG. 5 is a left side view of the container of FIG. 4, according to an illustrative embodiment;

FIG. 6 is a top view of the container of FIG. 4, according to an illustrative embodiment;

FIG. 7 is a rear perspective view of another exemplary container with a flexible strap opposite an inclined roller ramp and with a bail in a first position, according to an illustrative embodiment;

FIG. 8 is a left side view of the container of FIG. 7 with a bail in a first position, according to an illustrative embodiment;

FIG. 9 is a perspective view of a paint roller, according to an illustrative embodiment;

FIG. 10 is a perspective view of a paint brush with a handle, according to an illustrative embodiment;

FIG. 11 is a perspective view of a paint brush with a different handle, according to an illustrative embodiment;

FIG. 12 is a rear perspective view of the container of FIG. 7 with a roller positioned in the container opposite a flexible strap and with a bail in a second position, according to an illustrative embodiment;

FIG. 13 is a rear perspective view showing the container of FIG. 7 being held using the flexible strap and the bail in a third position, according to an illustrative embodiment;

FIG. 14 is a rear perspective view showing the container of FIG. 7 being held using the bail in the first position, according to an illustrative embodiment;

FIG. 15 is a rear perspective view of another exemplary container with a paint brush positioned in the container opposite an inclined roller ramp, according to an illustrative embodiment;

FIG. 16 is a front perspective view of still another exemplary container with a flexible strap opposite an inclined roller ramp, according to an illustrative embodiment;

FIG. 17 is a left side view of the container of FIG. 16, according to an illustrative embodiment;

FIG. 18 is a top view of the container of FIG. 16, according to an illustrative embodiment;

FIG. 19 is a right side view of an exemplary lid adapted for use on the container of FIG. 16, according to an illustrative embodiment;

FIG. 20 is a bottom perspective view of the lid of FIG. 19, according to an illustrative embodiment;

FIG. 21 is another bottom perspective view of the lid of FIG. 19, according to an illustrative embodiment;

FIG. 22 is a bottom view of the lid of FIG. 19, according to an illustrative embodiment;

FIG. 23 is a top view of the lid of FIG. 19, according to an illustrative embodiment;

FIG. 24 is a front view of the lid of FIG. 19, according to an illustrative embodiment;

FIG. 25 is a rear view of the lid of FIG. 19, according to an illustrative embodiment;

FIG. 26 is a front perspective view of the container of FIG. 16 with the lid of FIG. 19 positioned above the container, according to an illustrative embodiment;

FIG. 27 is a front perspective view of the container of FIG. 16 with the lid of FIG. 19 applied onto the container to seal the contents, according to an illustrative embodiment;

FIG. 28 is a left side view of the container and applied lid of FIG. 27, according to an illustrative embodiment;

FIG. 29 is a top view of the container and applied lid of FIG. 27, according to an illustrative embodiment;

FIG. 30 is a top perspective view of the container and applied lid of FIG. 27, and with a roller and brush stored inside the container, according to an illustrative embodiment;

FIG. 31 is a detailed view of the brush aperture of FIG. 30 with a brush handle extending through the aperture, according to an illustrative embodiment;

FIG. 32 is a detailed view of the roller aperture of FIG. 30 with a roller handle extending through the aperture, according to an illustrative embodiment;

FIG. 33 is a left side view of the container and applied lid of FIG. 30, with a roller and brush stored inside the container, according to an illustrative embodiment;

FIG. 34 is a front perspective view of yet another exemplary container, according to an illustrative embodiment;

FIG. 35 is a top view of the container of FIG. 34, according to an illustrative embodiment;

FIG. 36 is a bottom perspective view of an exemplary lid adapted for use on the container of FIG. 34, according to an illustrative embodiment;

FIG. 37 is another bottom perspective view of the lid of FIG. 36, according to an illustrative embodiment;

FIG. 38 is a bottom view of the lid of FIG. 36, according to an illustrative embodiment;

FIG. 39 is a top view of the lid of FIG. 36, according to an illustrative embodiment;

FIG. 40 is a side view of the lid of FIG. 36, according to an illustrative embodiment;

FIG. 41 is a front view of the lid of FIG. 36, according to an illustrative embodiment;

FIG. 42 is a rear view of the lid of FIG. 36, according to an illustrative embodiment;

FIG. 43 is a front perspective view of the container of FIG. 34 with the lid of FIG. 36 positioned above the container, according to an illustrative embodiment;

FIG. 44 is a right side perspective view of the container of FIG. 34 with the lid of FIG. 36 applied onto the container to seal the contents, according to an illustrative embodiment;

FIG. 45 is a left side view of the container and applied lid of FIG. 44, according to an illustrative embodiment;

FIG. 46 is a top view of the container and applied lid of FIG. 44, according to an illustrative embodiment;

FIG. 47 is a top perspective view of the container and applied lid of FIG. 44, and with a brush stored inside the container, according to an illustrative embodiment;

FIG. 48 is a detailed view of the brush aperture of FIG. 47 with a brush handle extending through the aperture, according to an illustrative embodiment;

FIG. 49 is a left side view of the container and applied lid of FIG. 44, and with an exemplary brush stored inside the container, according to an illustrative embodiment;

FIG. 50 is a left side view of the container with the applied lid of FIG. 44, and with another brush stored inside the container, according to an illustrative embodiment;

FIG. 51 is a front perspective view of another exemplary container with a bail, according to an illustrative embodiment;

FIG. 52 is a rear perspective view of another exemplary container with a molded handle opposite an inclined roller ramp, according to an illustrative embodiment;

FIG. 53 is a left side view of yet another exemplary container with a handle opposite an inclined roller ramp, and with a roller and brush positioned inside the container, according to an illustrative embodiment;

FIG. 54 is a perspective view of an exemplary lid adapted for use on a round container such as standard 5-gallon container, according to an illustrative embodiment;

FIG. 55 is a top perspective view of the exemplary lid of FIG. 54 applied to a round container such as a 5-gallon container to seal the contents, and with a roller and brush stored inside the container, according to an illustrative embodiment;

FIG. 56 is a detailed view of the brush aperture of FIG. 54 with a brush handle extending through the aperture, according to an illustrative embodiment;

FIG. 57 is a detailed view of the roller aperture of FIG. 54 with a roller handle extending through the aperture, according to an illustrative embodiment; and

FIGS. 58A-58F are diagrams of various exemplary flexibly self-sealing aperture opening designs, according to an illustrative embodiment.

### DETAILED DESCRIPTION

Embodiments of the provided subject matter relate to a resilient lid that can be sealably fitted to particular containers for holding a coating material, such as paint, and to methods to store paint and optionally hold/secure paint implements, such as a paint brush and/or a paint roller with the use of flexibly self-sealing apertures to store these implements within the container as well. These apertures can have “fingers” or other flexible member designs for example that can grip and/or form to a paint brush's handle and/or a paint roller's handle or shaft. These so called fingers or members will not only seal against the implement, they can also hold the implement or portions thereof at specified locations. This feature can allow the user to adjust how deep the paint brush's bristles are submerged into the paint within the container. The apertures can flex around, and seal around, various paint brush handles of various shapes, so that the paint brush can remain in the container, with the handle protruding out through the flexibly self-sealing aperture of the lid, and the self-sealing aperture can hold the handle at the user's chosen depth while they seal around the handle.

These apertures also remain sealed if no paint implement is being stored in this paint container system. The lid portion can further include a pull-tab to assist in removing the lid from the container. The lid can further include a rim that can correspond with the container's rim and allows easy on-off application of the lid while still providing an adequate seal. The container portion includes a container body, and can include a vertically oriented flexible strap attached to the rear side of the container body that can provides space for a user's hand between the container body and the flexible strap. In various embodiments the container can also include a flexible bail attached to the container's side walls as another method of holding and/or moving the container. These containers can include a magnetic means in the rear side for detachably holding a paint brush within the container's cavity when the container is actively being used. At the front side of various containers, opposite the magnet, there can be an inclined roller ramp with a pattern of raised portions on the surface for disbursing and scraping paint from a paint roller's applicator. Various containers, such as one, two, and/or five gallon buckets can incorporate a separate roller ramp implement that can be placed within the bucket and can help with evenly loading paint onto a paint roller's applicator. Various containers can have a rim at the front side that can include a ledge or slot to receive the flared end of the roller's handle that helps hold or center the roller's applicator within the cavity of the container. Although it is typically at the container portion's rim at the front side that is used to hold or hang a paint roller, other sides of the container can also be used in this same way during the painting process.

With reference to the drawings, like reference numerals designate identical or corresponding parts throughout the several views. However, the inclusion of like elements in different views does not mean a given embodiment necessarily includes such elements or that all embodiments of the invention include such elements.

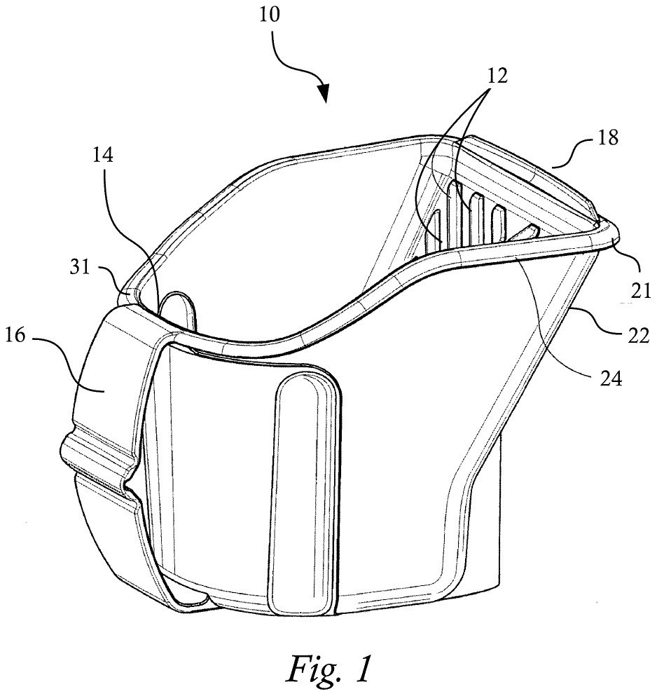

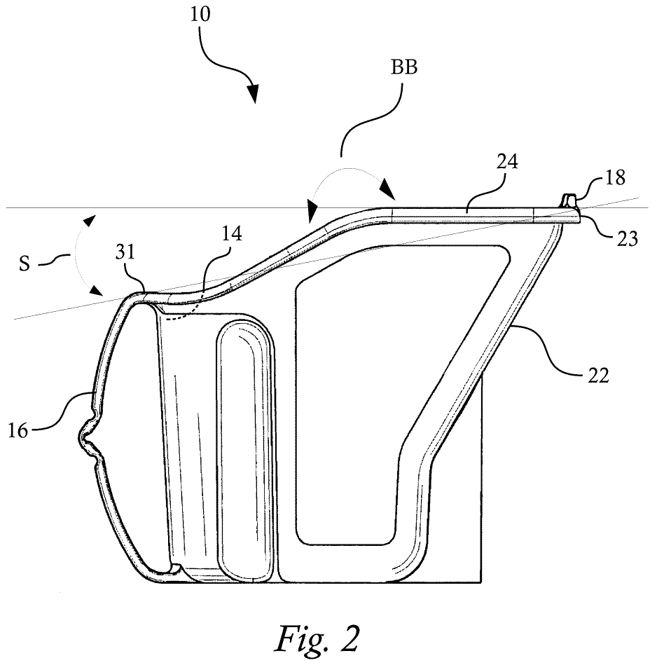

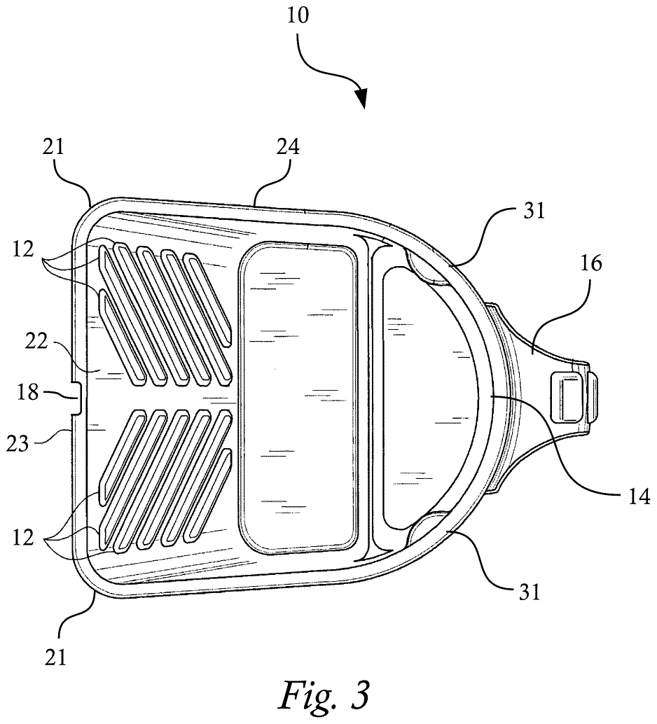

FIGS. 1-3 show various views of an exemplary container for holding a coating material, according to an illustrative embodiment. The container 10 includes a container body having a rim. Container 10 can have rim 24 with radiused corners 21 that pitch downward beginning at front side edge 23 then forms reflex angle BB of approximately 210 degrees on the left and right side edges that leads to rounded edge 31 at the rear side of the container. By way of non-limiting example, in various embodiments, angle BB can be in a range between approximately 150 degrees and approximately 180 degrees. The rim 24 can slope at angle S of between approximately 1 degree and approximately 15 degrees measured from the container's front side edge and terminating at the container's rear side edge, however, in various embodiments angle S can vary.

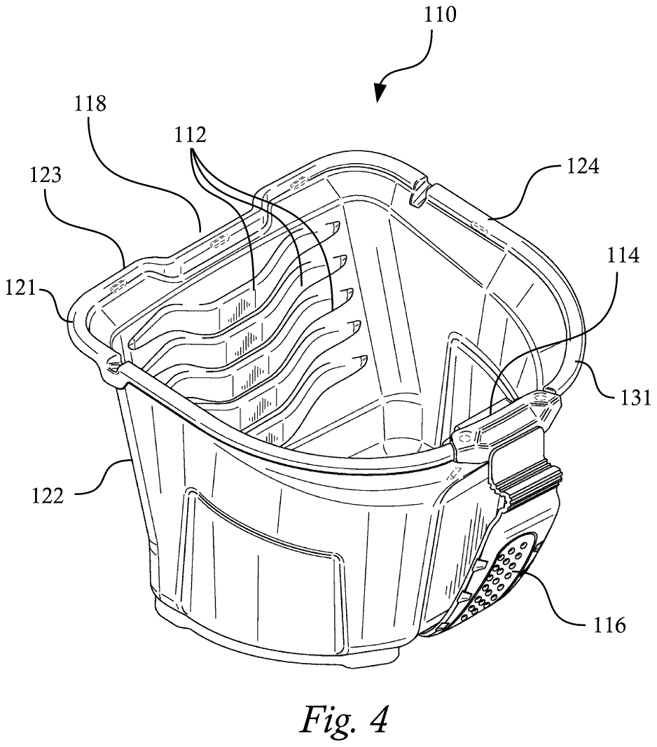

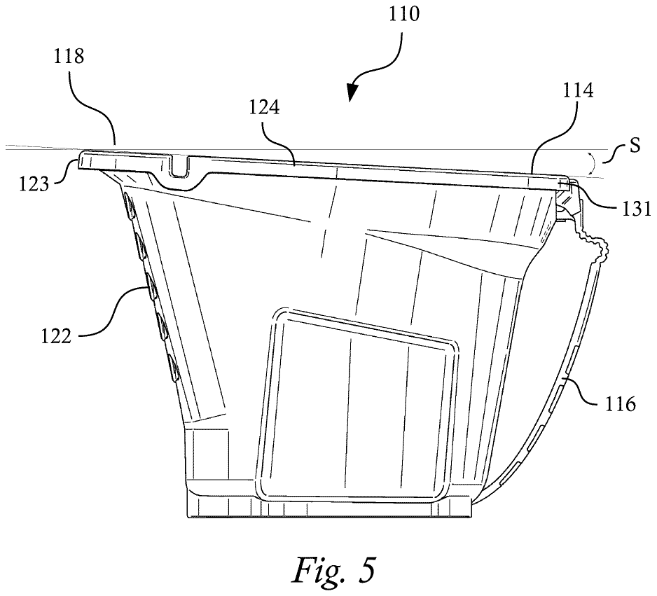

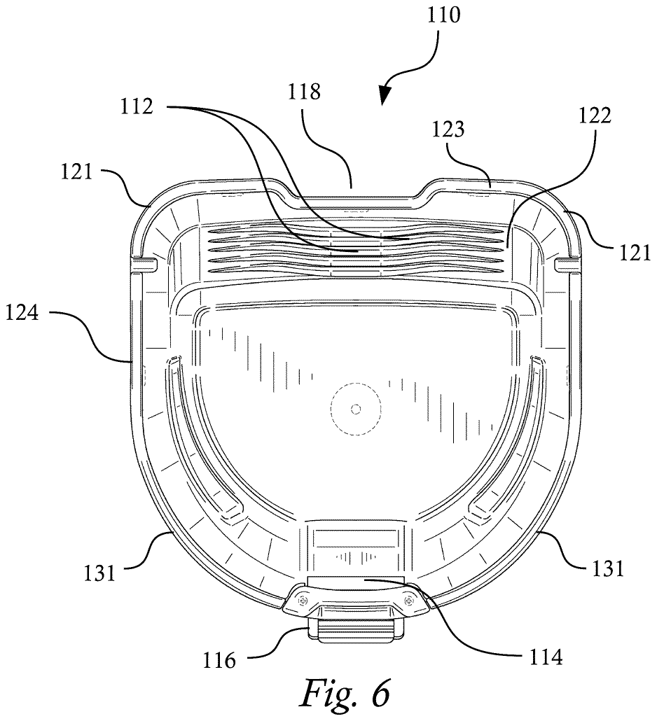

FIGS. 4-6 show various views of another exemplary container for holding a coating material, according to an illustrative embodiment. Container 110 can have rim 124 with radiused corners 121 that also pitches downward from front side edge 123 that leads to a rounded edge 131 at the rear side of the container. The rim 124 can slope at angle S of between approximately 1 degree and approximately 15 degrees measured from the container's front side edge and terminating at the container's rear side edge, however, in various embodiments angle S can vary.

Referring now to FIGS. 1-6, in various embodiments, no side of these container's rims are parallel with any other. These containers can include a front, a rear, a right side, a left side, and a bottom that define a cavity for receiving a coating material. The right side and left side can each include an inwardly extending portion that extends into the cavity. A rear side can include an inwardly extending portion that extends into the cavity that can include a magnetic means 14 and 114 for detachably holding a painting implement, such as a brush to the interior of the container. Front side 22 and 122 can include an inwardly extending portion that extends into the cavity that can include an inner surface portion with a plurality of scraper regions 12 and 112 projecting therefrom for scraping paint off from a painting implement, such as a roller. The front side can further include a slot or ledge 18 and 118 in the rim for holding a roller handle at its flared end portion to the interior of the container. There can be a flexible strap 16 and 116 attached to the rear of the container body. Flexible strap 16 and 116 can have a first end attached to the rear side of the container body proximate a top of the rear side and a second end attached to the rear side of the container body proximate a bottom of the rear side. The flexible strap 16 and 116 can be stretched to provide space for a user's hand between the rear side of the container body and the strap.

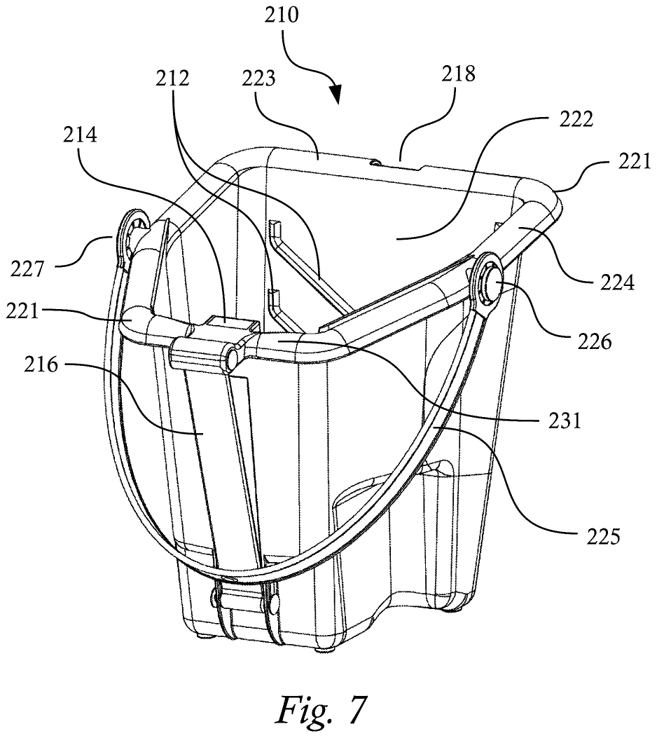

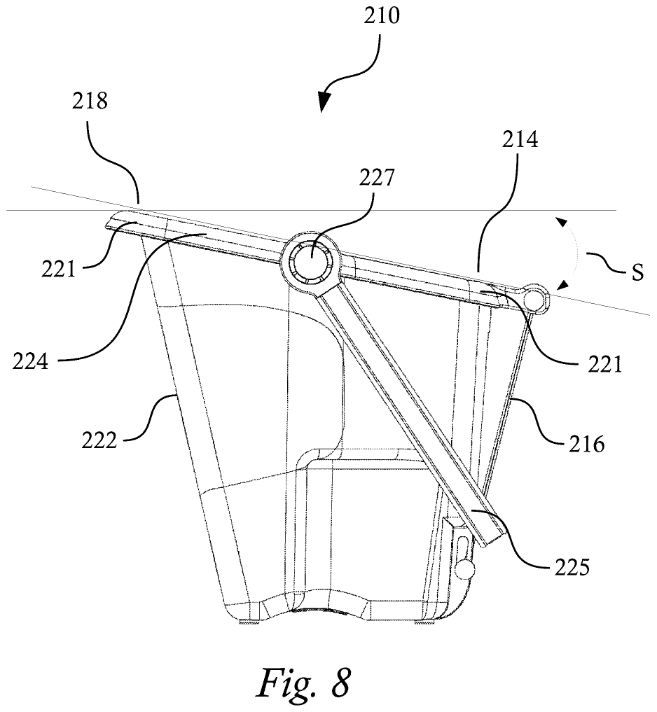

FIGS. 7 and 8 show various views of another exemplary container for holding a coating material, according to an illustrative embodiment. This container 210 can include a container body having a rim 224 with radiused corners 221 and are pitched downward beginning at the front side edge 223 that leads to a rounded edge 231 at the rear side of the container. In various embodiments, no side of this container's rim is parallel with any other. The container includes a container body having a front, a rear, a right side, a left side, and a bottom that define a cavity for receiving a coating material. The right side and left side can each include an inwardly extending portion that extends into the cavity. A rear side that can include an inwardly extending portion that extends into the cavity that can include a magnetic means 214 for detachably holding a painting implement, such as a brush to the interior of the container. Front side 222 can include an inwardly extending portion that extends into the cavity that can include a plurality of inner surface scraper regions 212 projecting therefrom for scraping paint off from a painting implement, such as a roller. There can be a slot or ledge 218 in the front side rim for holding a roller handle at its flared end portion. A flexible strap 216 can be further attached to the rear side of the container body. The flexible strap can have a first end attached to the rear side of the container body portion proximate a top of the rear side and a second end attached to the rear side of the container body portion proximate a bottom of the rear side. The flexible strap 216 can be stretched to provide space for a user's hand between the rear side of the container body and the strap. The container can include a pivotable bail 225 in a first position that can be pivotably attached with ears 226 and 227 that project outward from the sides of the container. Bail 225 is shown in a first position in FIGS. 7 and 8, however, the bail 225 can pivot around the ears 226 and 227 into various positions.

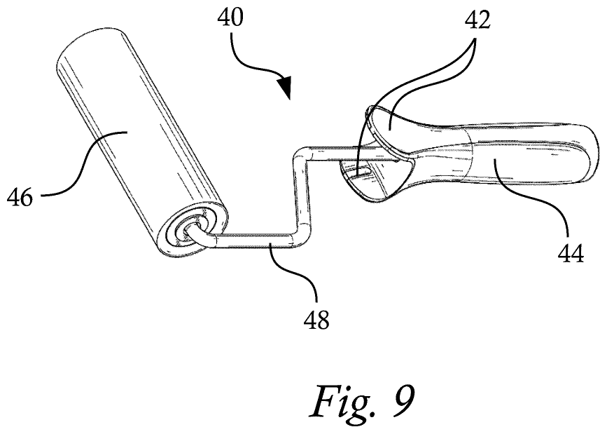

FIG. 9 is a perspective view of a paint roller, according to an illustrative embodiment. The paint roller 40 can include a handle 44. The roller handle can include flared end portions 42 that can be used to hook the paint roller 40 onto another surface to help hold the paint roller in place. The roller can further include a shaft 48 and a paint applicator 46 that is used to apply a coating material, such as paint.

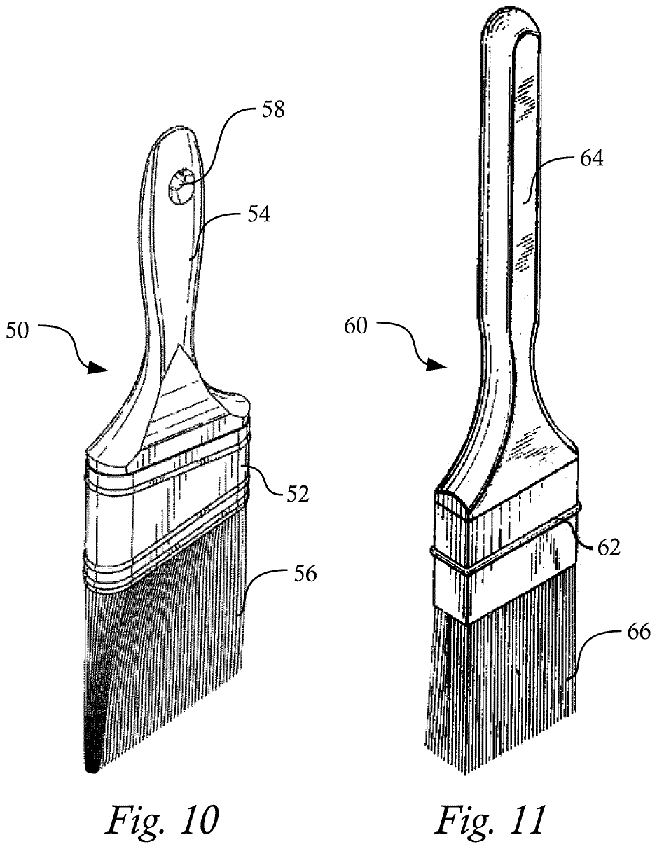

FIGS. 10 and 11 show perspective views of exemplary paint brushes, according to an illustrative embodiment. These brushes 50 and 60 can include handles 54 and 64. Brush 54 shows an optional through hang hole 58. Both brushes can have a metal ferrule 52 and 62 and bristles 56 and 66 that are used to apply a coating material, such as paint.

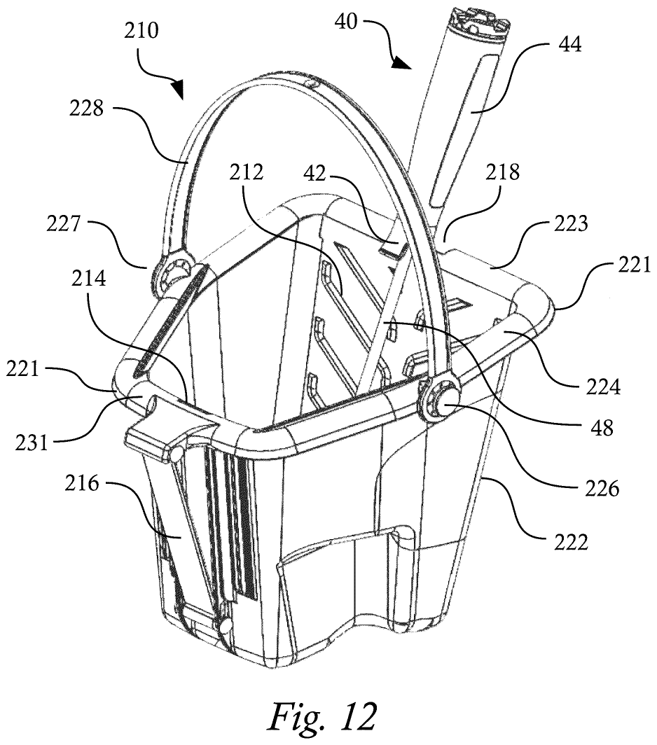

FIG. 12 is a rear perspective view of the container of FIG. 7 with a roller positioned in the container opposite a flexible strap and with a bail in a second position, according to an illustrative embodiment. The container 210 can have a container body having a rim 224 with radiused corners 221 that is pitched downward beginning at the front side edge 223 that leads to a slightly curved edge 231 at the rear side of the container. In various embodiments, no side of this container's rim is parallel with any other. This container includes a container body having a front, a rear, a right side, a left side, and a bottom that define a cavity for receiving a coating material. The right side and left side can each include an inwardly extending portion that extends into the cavity. A rear side that can include an inwardly extending portion that extends into the cavity that can include a magnetic means 214 for detachably holding a painting implement, such as a brush to the interior of the container. Front side 222 can include an inwardly extending portion that extends into the cavity that can include a plurality of inner surface scraper regions 212 projecting therefrom for scraping paint off from a painting implement, such as a roller 40. There can be a slot or ledge 218 in the front side rim for holding a roller handle 44 at its flared end portion 42 to the interior of the container. A flexible strap 216 can be attached to the rear side of the container body. The flexible strap can have a first end attached to the rear side of the container body portion proximate a top of the rear side and a second end attached to the rear side of the container body portion proximate a bottom of the rear side. In various embodiments, the flexible strap 216 may be stretched to provide space for a user's hand between the rear side of the container body and the strap. The container can include a pivotable bail 228 in a second position that can be pivotably attached with ears 226 and 227 that project outward from the sides of the container. Bail 228 is shown in a second position in FIG. 12, however, the bail 228 can pivot around the ears 226 and 227 into various positions.

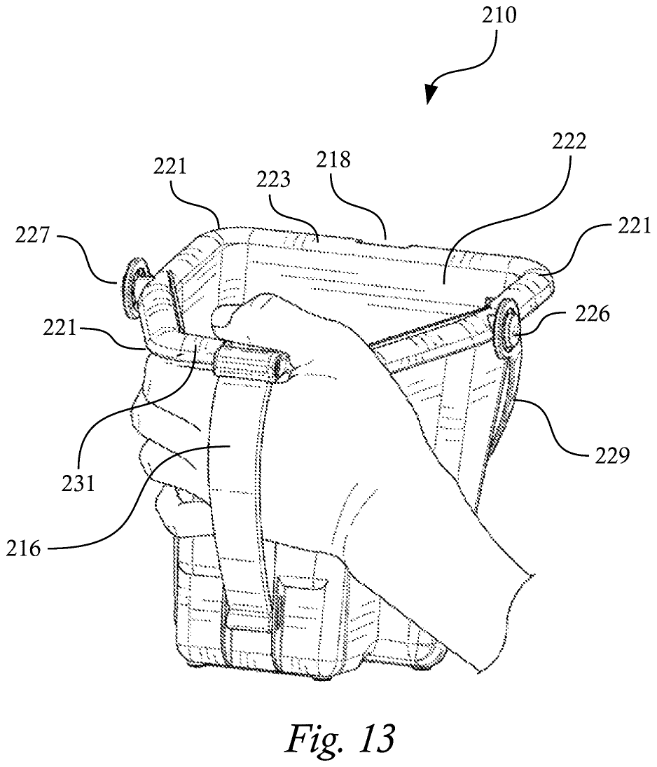

FIG. 13 is a rear perspective view showing the container of FIG. 7 being held using the flexible strap and the bail in a third position, according to an illustrative embodiment. The container 210 can include a container body having a rim 224 with radiused corners 221 that is pitched downward beginning at the front side edge 223 that leads to a slightly curved edge 231 at the rear side of the container. In various embodiments, no side of this container's rim is parallel with any other. This container can include a container body having a front, a rear, a right side, a left side, and a bottom that define a cavity for receiving a coating material. The right side and left side can each include an inwardly extending portion that extends into the cavity. A rear side that can include an inwardly extending portion that extends into the cavity that can include a magnetic means 214 for detachably holding a painting implement, such as a brush to the interior of the container. Front side 222 can include an inwardly extending portion that extends into the cavity that can include a plurality of inner surface scraper regions 212 projecting therefrom for scraping paint off from a painting implement, such as a roller. There can be a slot or ledge 218 in the front side rim for holding a roller handle at its flared end portion to the interior of the container. A flexible strap 216 can be attached to the rear side of the container body. The flexible strap can have a first end attached to the rear side of the container body portion proximate a top of the rear side and a second end attached to the rear side of the container body portion proximate a bottom of the rear side. The flexible strap 216 can be stretched to provide space for a user's hand between the rear side of the container body and the strap. The container can include a pivotable bail 229 in a third position that can be pivotably attached with ears 226 and 227 that project outward from the sides of the container. Bail 229 is shown in a third position in FIG. 13, however, the bail 229 can pivot around the ears 226 and 227 into various positions.

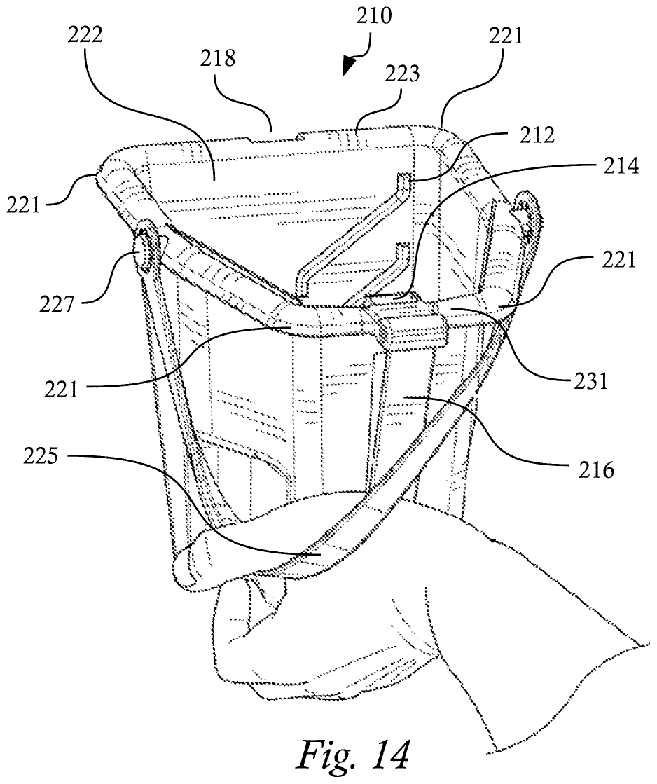

FIG. 14 is a rear perspective view showing the container of FIG. 7 being held using the bail in the first position, according to an illustrative embodiment. The container 210 can include a container body having a rim 224 with radiused corners 221 that is pitched downward beginning at the front side edge 223 that leads to a slightly curved edge 231 at the rear side of the container. In various embodiments, no side of this container's rim is parallel with any other. This container can include a container body having a front, a rear, a right side, a left side, and a bottom that define a cavity for receiving a coating material. The right side and left side can each include an inwardly extending portion that extends into the cavity. A rear side that can include an inwardly extending portion that extends into the cavity that can include a magnetic means 214 for detachably holding a painting implement, such as a brush to the interior of the container. Front side 222 can include an inwardly extending portion that extends into the cavity that can include a plurality of inner surface scraper regions 212 projecting therefrom for scraping paint off from a painting implement, such as a roller. There can be a slot or ledge 218 in the front side rim for holding a roller handle at its flared end portion to the interior of the container. A flexible strap 216 can be attached to the rear side of the container body. The flexible strap can have a first end attached to the rear side of the container body portion proximate a top of the rear side and a second end attached to the rear side of the container body portion proximate a bottom of the rear side. In various embodiments, the flexible strap 216 may be stretched to provide space for a user's hand between the rear side of the container body and the strap. The container can include a pivotable bail 225 in a first position that can be pivotably attached with ears 226 and 227 projecting outward from the sides of the container. As shown in this view, the bail 225 can also be used in the first position to hold the container without interference from the flexible strap 216.

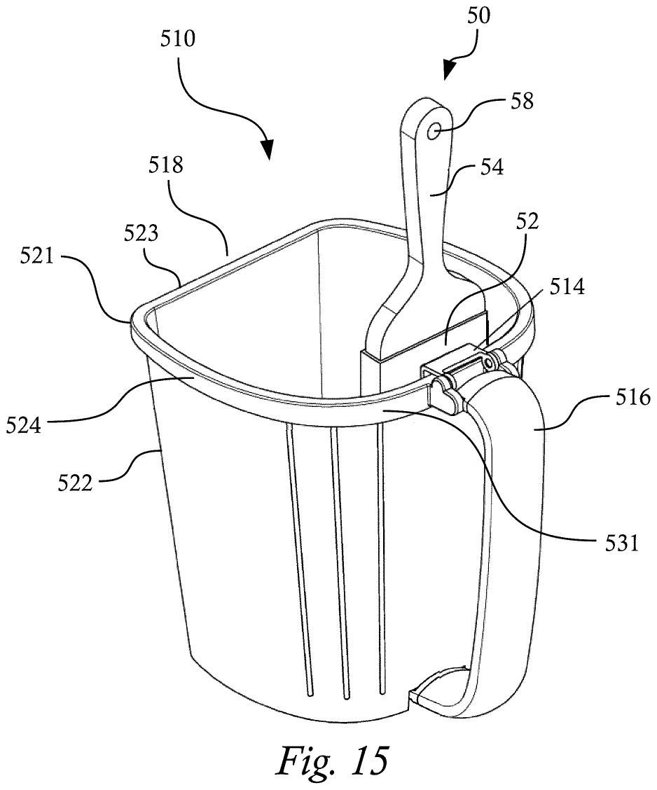

FIG. 15 is a rear perspective view of another exemplary container with a paint brush positioned in the container opposite an inclined roller ramp, according to an illustrative embodiment. The container 510 can include a magnetic means 514 located in the rear side for detachably holding a painting implement, such as a brush 50 at the brush's metal ferrule 52 to the interior of the container. In various embodiment herein, these magnetic means, located in the rear side of these hand-held paint containers, engage with a paint brush's metal ferrule. The container includes a container body having a rim 524 with radiused corners 521. The container can have a front side edge 523 and can be rounded at the rear side 531. In various embodiments, no side of this container's rim is parallel with any other side. This container can include a container body having a front, a rear, a right side, a left side, and a bottom that define a cavity for receiving a coating material. A flexible strap 516 can be attached to the rear side of the container body. The flexible strap can have a first end attached to the rear side of the container body portion proximate a top of the rear side and a second end attached to the rear side of the container body portion proximate a bottom of the rear side. The flexible strap 516 can be stretched to provide space for a user's hand between the rear side of the container body and the strap.

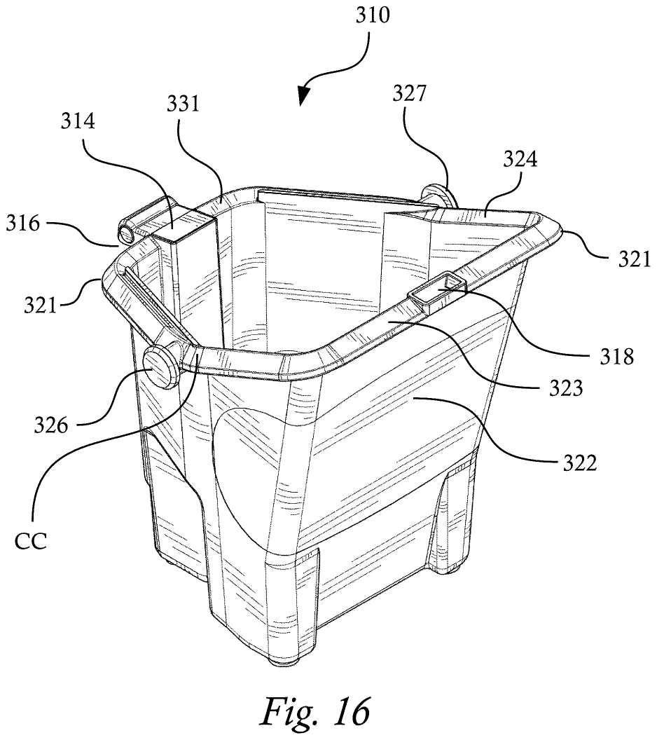

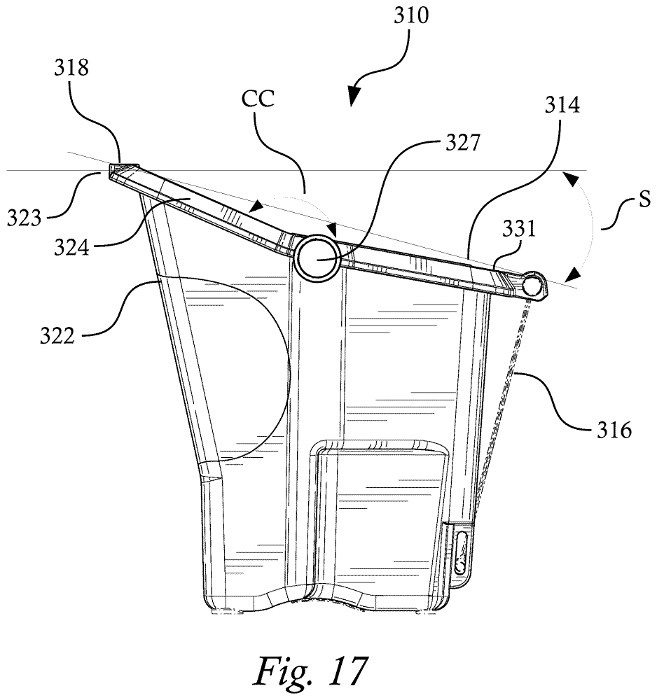

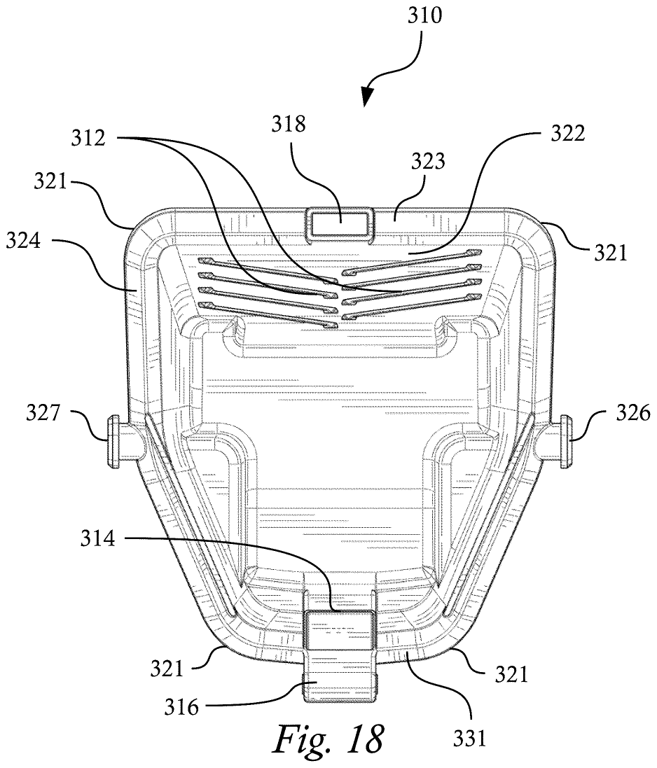

FIGS. 16-18 are various views of another exemplary container with a flexible strap opposite an inclined roller ramp, according to an illustrative embodiment. The container 310 includes a container body having a rim 324 with radiused corners 321 that is pitched downward beginning at the front side edge 323 that leads to a slightly curved back edge 331 at the rear side of the container. Rim 324 includes a bent portion on the left and right side edges that can be at an obtuse angle CC of approximately 165 degrees. By way of non-limiting example, in various embodiments, angle CC can be in a range between approximately 150 degrees and approximately 180 degrees. The rim can slope at angle S of between approximately 1 degree and approximately 15 degrees measured from the container's front side edge and terminating at the container's rear side edge, however, in various embodiments angle S can vary. In various embodiments, no side of the container's rim is parallel with any other. The container includes a container body having a front, a rear, a right side, a left side, and a bottom that define a cavity for receiving a coating material. The right side and left side can each include an inwardly extending portion that extends into the cavity. A rear side can include an inwardly extending portion that extends into the cavity that can include a magnetic means 314 for detachably holding a painting implement, such as a brush to the interior of the container. Front side 322 can include an inwardly extending portion that extends into the cavity that can include a plurality of inner surface scraper regions 312 projecting therefrom for scraping paint off from a painting implement, such as a roller. There can be a slot or ledge 318 in the front side rim for holding a roller handle at its flared end portion. A flexible strap 316 can be attached to the rear side of the container body. The flexible strap can have a first end attached to the rear side of the container body portion proximate a top of the rear side and a second end attached to the rear side of the container body portion proximate a bottom of the rear side. In various embodiments, the flexible strap 316 may be stretched to provide space for a user's hand between the rear side of the container body and the strap. The container can include a bail attached with ears 326 and 327 projecting outward from the sides of the container.

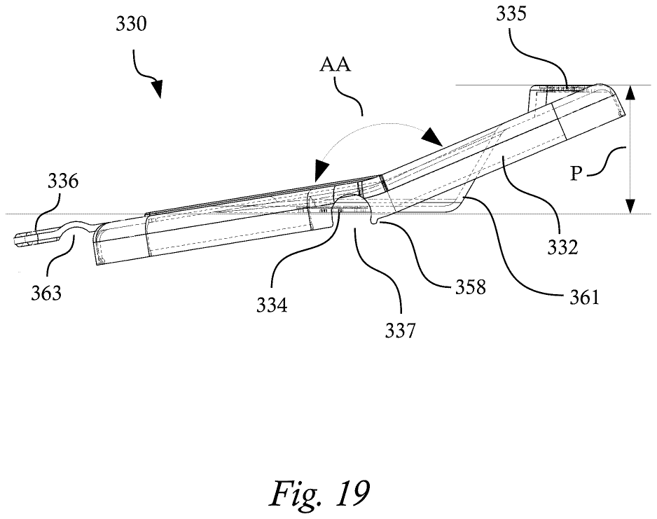

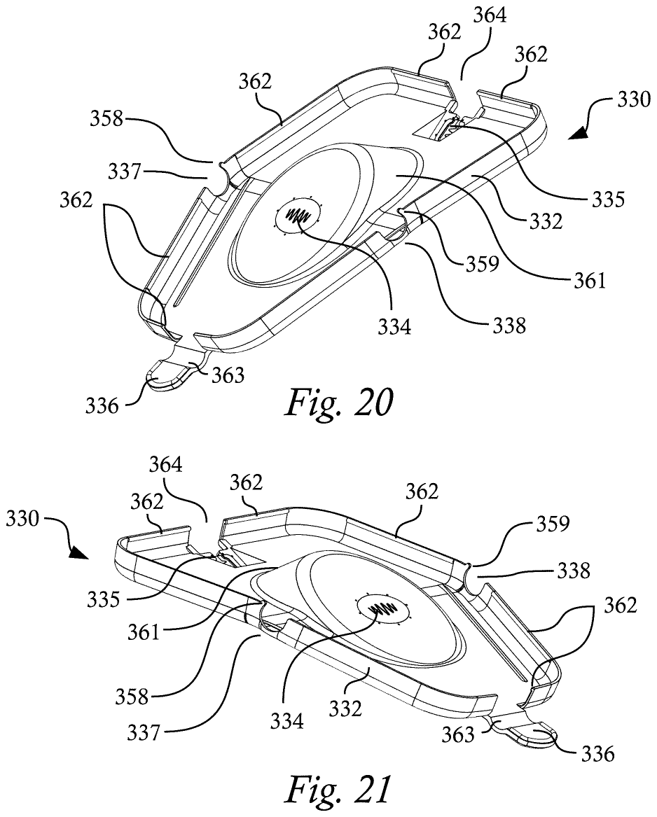

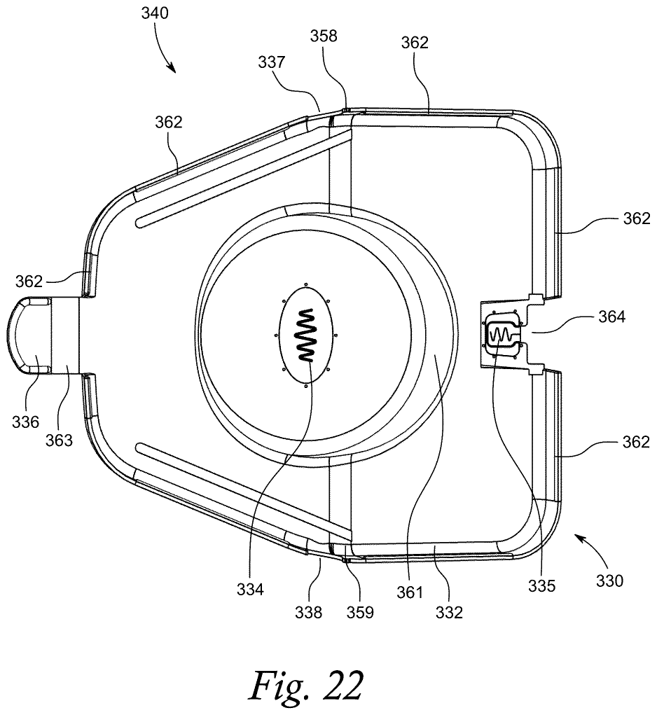

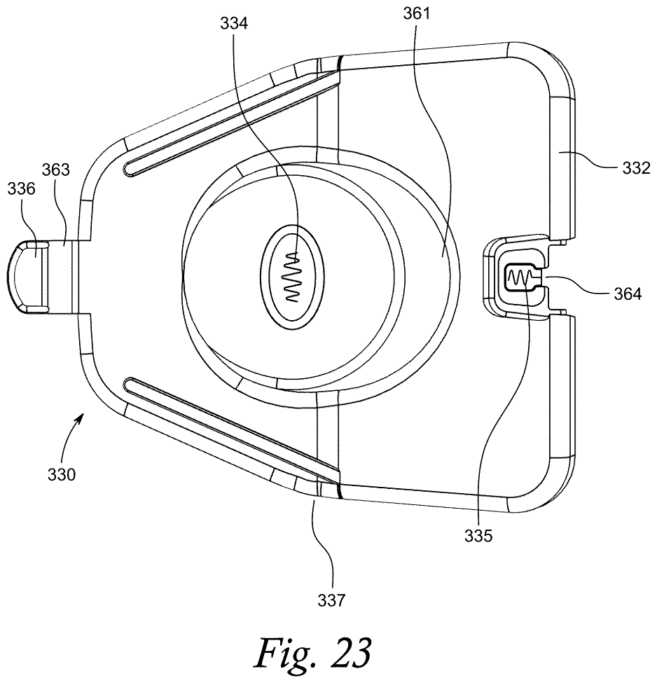

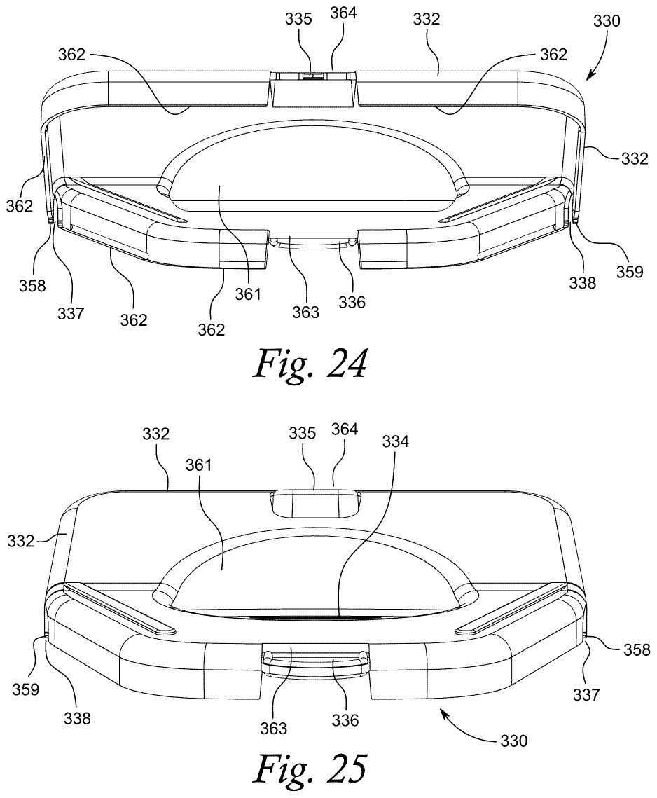

FIGS. 19-25 are various views of an exemplary lid adapted for use on the container of FIG. 16, according to an illustrative embodiment. The lid 330 can have a rim 332 that frictionally engages with a specific paint container rim with lid flanges 362. Lid flanges 362 can extend out from the bottom region of the rim so that the flanges can engage under the edge of the container's rim. When the lid is engaged with the rim of the container, the flange can be hooked under the edge of the container's rim, thereby holding the lid in place and sealing the lid to the container. In various embodiments, the lid flanges can be an extended ridge that stretches along a lower portion of the lid's rim. Lid flanges can be a raised ridge that sticks out from the lower portion of the lid's rim, extending along a portion of the lid's rim. In various embodiments, the lid flanges may be short sections of raised material, that can even be in the form of raised dots, a string of raised dots, one or more shot sections, or other possible configurations. In various embodiments, the radiused corners of the lid may be free from lid flanges. Put another way, the lid flanges may exist only in the straight sections of the lid rim, but not the corners. With the corners being free from lid flanges, the lid can more easily be managed and removed from the container.

These lid flanges can also engage with the container at the lid's rim's bent portion on the left and right side edges. The rim's bent portion can include an obtuse angle AA that can be approximately 165 degrees, located on the left and right side edges of the lid, that effectively seals the lid to the container, while still making the lid easy to apply and remove. By way of non-limiting example, in various embodiments, angle AA can be in a range between approximately 150 degrees and approximately 180 degrees. These flanges of the lid are not located in the radiused corners of the lid in order to facilitate the easy removal of the lid from the container while still providing a secure sealed fit. Put another way, the radiused corners of the lid are free from lid flanges, which allows the lid to be easily removed from the container.

The lid's rim can have a left rim portion and a right rim portion. Left rim portion and right rim portion can both be referred to as side rim portions. Side rim portions can have concave angles AA. Concave angles AA can be obtuse angles that can be in a range between approximately 110 degrees and approximately 178 degrees. In various embodiments, concave angles AA can be approximately 165 degrees. Concave angle AA can divide the side rim portion into a front region of the side rim portion and a rear region of the side rim portion. The front region of the left side rim portion and the rear region of the left side rim portion can lie in a left side plane, and the right front region of the right side rim portion and the right rear region of the right side rim portion can lie in a right side plane.

The lid also allows for a paint container liner to be used within the container body. Such liners are often used to assist in clean-up once the paint project is complete. Regardless of whether a liner is used or not, the lid creates an effective seal on the container. The lid can include flexibly self-sealing apertures 334 and 335 to allow for optional paint implement storage. The aperture 334 is particularly designed to hold a paint brush handle of various sizes and shapes, such as brush handles 54 and 64 shown in FIGS. 10-11, while still maintaining a seal around these various brush handles. In various embodiments, apertures 334 and 335 may be parallel, shown at P, to the container's bottom when the lid is applied. In particular, aperture 334 can be parallel to the container's bottom due to the concave nature of the lid's surface at 361. In various embodiments, aperture 334 can have graduated curved fingers beginning at each end of the aperture, but not all such apertures have to graduate in this manner. When the brush handle is pulled up through the aperture, these fingers can grip and hold the handle to prevent the handle from slipping. Furthermore, aperture 334 can allow the brush handle to be slid up and down through the aperture opening in order to raise or lower the brush's bristles in the coating material, held within the container body portion, regardless of what the level of said coating material might be. Aperture 335 can be designed to accept a paint roller's shaft such as roller handle 48 shown in FIG. 9, and can have similar fingers found in aperture 334. The fingers of both apertures can interlock when not being used to create an airtight seal. These interlocking and sealing fingers of apertures 334 and 335 result in apertures 334 and 335 remaining sealed regardless of whether or not a handle of a paint implement is extending through the aperture. The lid can be applied to the container while the paint implement is in the container, and the handle of the paint implement can be passed through the aperture when the lid is being applied to the container. The lid and the container together can form a paint container system.

When a paint implement, such as a roller, is used at flexibly self-sealing aperture 335 the lid's rim can include a gap 364 that allows the lid to be applied to and removed from the container, even while the implement remains in the container. Put another way, in various embodiments the lid's rim can have a gap, and the self-sealing aperture 335 can abut the gap. In this way, when the lid is applied to a container that has a roller in the container, the handle of the roller can pass through the gap and into the self-sealing aperture. When the sealed lid is removed later, the handle of the roller can exit the self-sealing aperture and pass through the gap in the lid's rim. Gap 364 can be adjacent to the self-sealing aperture 335, so that an implement extending through the self-sealing aperture can make a lateral transition into the gap without needing to be pulled out of the self-sealing aperture in a vertical direction. That is to say, when the self-sealing aperture is in an open conformation, the self-sealing aperture and the gap can form a continuous opening. When the rim of the lid meets the rim of the container, the gap 364 lies on top of the rim of the container so that the gap does not cause a loss of seal. That is to say, the gap does not extend beyond the rim of the lid.

The lid can include a pull-tab 336 that in this configuration is located at the rear side of the lid and is designed to form over the container's vertical hand strap at 363. The pull-tab can be used to assist in removing the lid from the container by means of an upwardly pull action that continues upward and towards the front of the container until the lid is removed. The pull-tab can be in a variety of other locations around the rim 332 and can be manipulated in numerous other ways in order to remove it from the container. The lid includes notches 337 and 338 that allow this configuration to fit over certain container ears, such as ears 326 and 327 in FIGS. 16-18. The left side rim portion can have a notch 337 between the front region of the left side rim portion and the rear region of the left side rim portion. The right side rim portion can have a notch 338 between the front region of the right side rim portion and the rear region of the right side rim portion. These notches can open downward, away from angle AA. Notches 337 and 338 can define holding areas that can be semi-circular, with the sides of the holding area defined by the notches. The holding area can be partially encircled by the sides of the notches, with the sides of the notches encircling more than 180 degrees of the holding areas. The bottom edge of the rim can have at least one retention tab such that partially defines a holding area. The retention tabs 358 and 359 extend around the holding area to help to secure an object, such as container ears 326 and 327, within the holding area. Ears 326 and 327 are used to attach a bail to the container. When a user lifts the pull-tab 336 of the lid, the front portion of the lid and the rear portion of the lid can flex towards each other by flexing approximately in the region of the notches. As the front portion of the lid and the rear portion of the lid flex towards each other at these notches, the notches can be slightly deformed, causing the retention tabs 358 and 359 to rotate around the object such as the ears of the container until the opening to the holding area is large enough for the object held in the holding area, such as ears 326, 327, to be released. When the lid is applied to the container, the container's bail, that is connected to the container's ears, remains fully functional and without any interference from the lid.

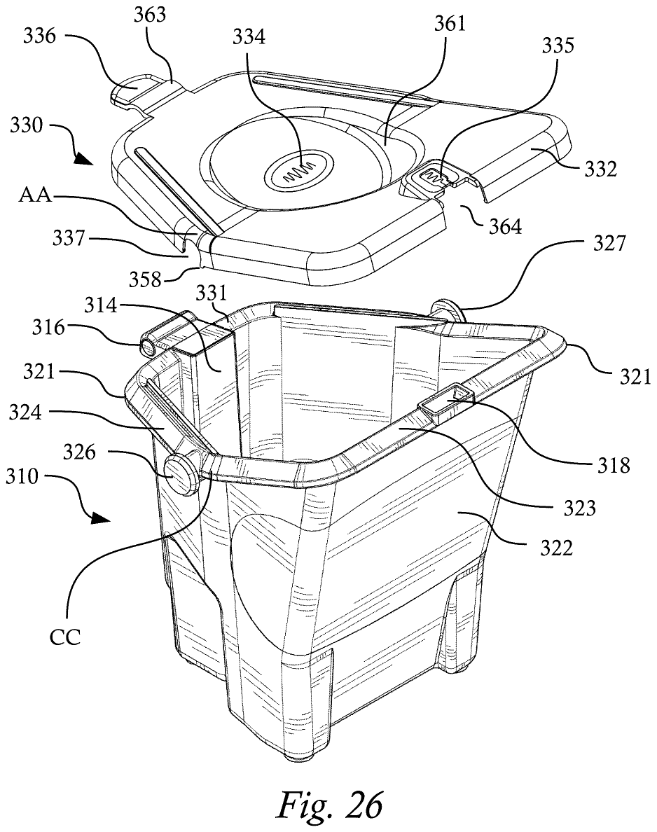

FIG. 26 is a front perspective view of the container of FIG. 16 with the lid of FIG. 19 positioned above the container, according to an illustrative embodiment. The lid 330 includes flexibly self-sealing apertures 334 and 335 to allow for optional paint implement storage, with the handles of the paint implement(s) extending upwards through the flexibly self-sealing apertures when the lid is applied to the container. These apertures also remain sealed if no paint implement is used and in this example, but not all, can be parallel to the bottom of the container 310 when the lid is applied. When a paint implement, such as a brush is used, aperture 334 allows the brush handle to slide up and down through the aperture opening in order to raise or lower the brush's bristles in the coating material, held within the container body portion, regard-less of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position When a paint implement, such as a roller, is used at aperture 335 the lid includes a gap 364 in the rim that allows the lid to be applied to and removed from the container, even while the implement remains in the container. Put another way, in various embodiments the lid's rim can have a gap, and the self-sealing aperture 335 can abut the gap. In this way, when the lid is applied to a container that has a roller in the container, the handle of the roller can pass through the gap and into the self-sealing aperture. When the sealed lid is removed later, the handle of the roller can exit the self-sealing aperture and pass through the gap in the lid's rim. Gap 364 can be adjacent to the self-sealing aperture 335, so that an implement extending through the self-sealing aperture can make a lateral transition into the gap without needing to be pulled out of the self-sealing aperture in a vertical direction. That is to say, when the self-sealing aperture is in an open conformation, the self-sealing aperture and the gap can form a continuous opening. When the rim of the lid meets the rim of the container, the gap 364 lies on top of the rim of the container so that the gap does not cause a loss of seal. That is to say, the gap does not extend beyond the rim of the lid.

The lid can include a pull-tab 336 that in this particular configuration is designed to form over the container's vertical hand strap at 363 located at the rear side of the lid and is used to assist in removing the lid from the container by means of an upwardly pull action that continues upward and towards the front side of the container until the lid is removed. The pull-tab can be in a variety of other locations along the rim of the lid portion and can be manipulated in numerous other ways in order to remove the lid from the container. The lid portion has a rim 332 that frictionally engages with the container's rim in certain flange area locations including at the lid's rim that includes bent portion on the left and right side edges at an obtuse angle AA located on the side edges that match the container's rim bent portion CC and that effectively seals the lid to the container, while still making the lid easy to apply and remove. By way of non-limiting example, in various embodiments lid rim portion's angle AA and container rim portion's angle CC can be in a range between approximately 150 degrees and approximately 180 degrees. The lid's engagement with the container also allows for a liner to be used within the container body. Such liners are often used to assist in clean-up once the paint project is complete. Regard-less of whether a liner is used or not, the lid creates an effective seal on the container. The lid portion further includes notches 337 and 338 that allows the lid to fit securely over the container body's ears 326 and 327. In other lid portion configurations that work in conjunction with other exemplary container portions described herein, there may not be a need for such notches 337 and 338 in order for the lid to fit securely over the container's rim. In various embodiments the container portion 310 includes a container body having a rim 324 with radiused corners 321 and is pitched downward beginning at the front side edge 323 and leads to a slightly curved edge 331 at the rear side. In various embodiments, no side of the container portion's rim or lid portion's rim are parallel with any other side. The container portion can include a container body having a front, a rear, a right side, a left side, and a bottom that define a cavity for receiving a coating material. The container's front side 322 can include an inwardly extending portion that extends into the cavity that can include a slot or ledge 318 in the front for holding a paint implement handle, such as a roller handle, at its flared end portions. Ears 326 and 327 that project outward from the sides of the container can be used to attach a bail. With the lid portion applied to the container portion, the container's bail can remain fully functional and without any interference from the lid. The container portion can include a flexible strap 316 attached to the rear side of the container body. The flexible strap can have a first end attached to the rear side of the container body portion proximate a top of the rear side and a second end attached to the rear side of the container body portion proximate a bottom of the rear side. The flexible strap 316 can be stretched to provide space for a user's hand between the rear side of the container body and the strap.

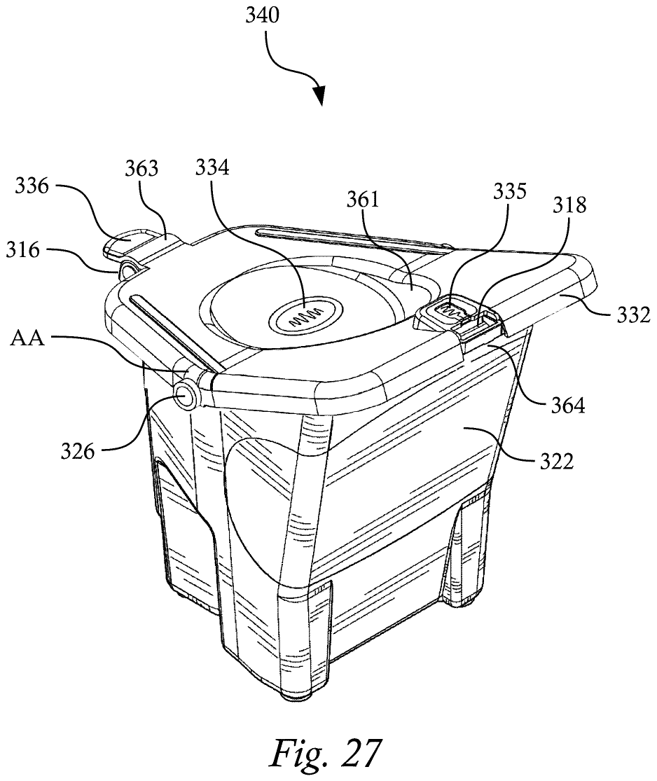

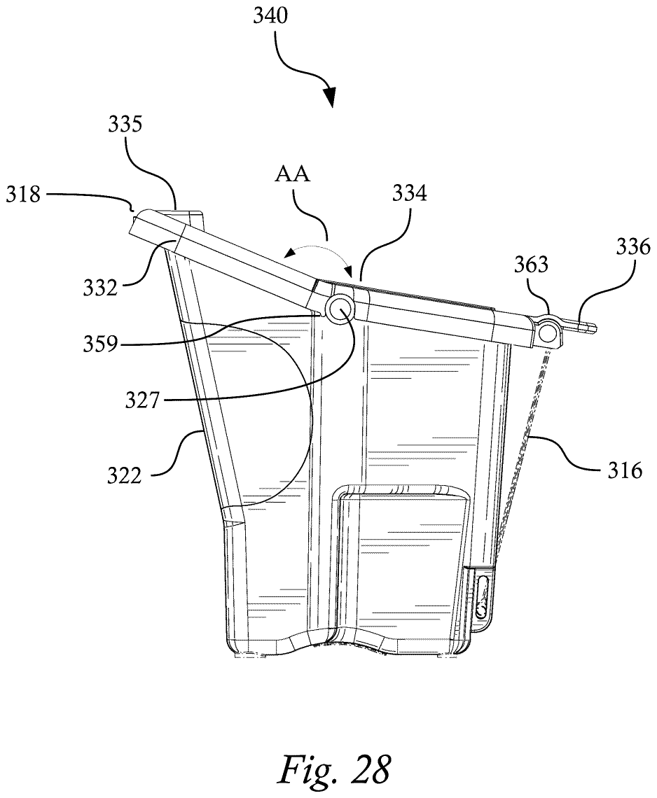

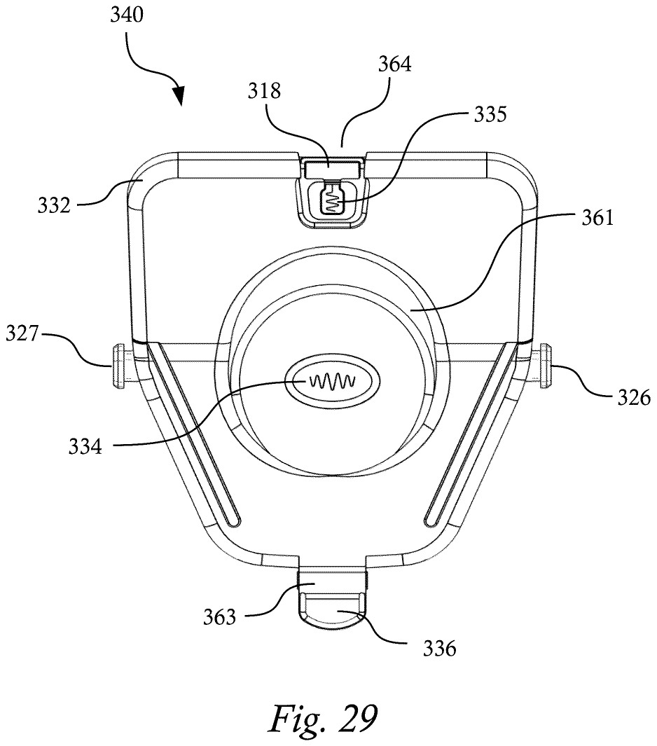

FIGS. 27-29 are various view of the container of FIG. 16 with the lid of FIG. 19 ap-plied onto the container to seal the contents, according to an illustrative embodiment. Paint container system 340 can include a sealed lid applied to a hand-held paint container. The lid has a rim 332 that can include flanges that frictionally engage with the container's rim in certain locations, including at the lid's rim obtuse angle AA located on the side edges that match the container's rim and effectively seals the lid to the container, while still making the lid easy to apply and remove. By way of non-limiting example, in various paint container systems the lid rim portion's angle AA and container rim portion's angle CC can be in a range between approximately 150 degrees and approximately 180 degrees. The lid's engagement with the container also allows for a liner to be used within the container body. Such liners are often used to assist in clean-up once the paint project is complete. Regardless of whether a liner is used or not, the lid creates an effective seal on the container. The lid portion can have flexibly self-sealing apertures 334 and 335 to allow for optional paint implement storage, with the handles of the paint implement(s) extending upwards through the flexibly self-sealing apertures when the lid is applied to the container. These apertures also remain sealed if no paint implement is used and in this example, but not all, can be parallel to the bottom of the container when the lid portion is applied. When a paint implement, such as a brush is used, aperture 334 allows the brush handle to slide up and down through the aperture opening in order to raise or lower the brush's bristles in the coating material, held within the container body portion, regardless of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position. When a paint implement, such as a roller, is used at aperture 335 the lid portion includes a gap 364 that allows the lid to be applied to and removed from the container, even while the implement remains in the container. Put another way, in various embodiments the lid's rim can have a gap, and the self-sealing aperture 335 can abut the gap. In this way, when the lid is applied to a container that has a roller in the container, the handle of the roller can pass through the gap and into the self-sealing aperture. When the sealed lid is removed later, the handle of the roller can exit the self-sealing aperture and pass through the gap in the lid's rim. Gap 364 can be adjacent to the self-sealing aperture 335, so that an implement extending through the self-sealing aperture can make a lateral transition into the gap without needing to be pulled out of the self-sealing aperture in a vertical direction. That is to say, when the self-sealing aperture is in an open conformation, the self-sealing aperture and the gap can form a continuous opening. When the rim of the lid meets the rim of the container, the gap 364 lies on top of the rim of the container so that the gap does not cause a loss of seal. That is to say, the gap does not extend beyond the rim of the lid.

The lid can include a pull-tab 336 that in this particular configuration is designed to form over the container portion's vertical hand strap at 363 located at the rear side of the lid. The pull-tab can be used to assist in removing the lid from the container by the use of an upwardly pull action that continues upward and towards the front of the container until the lid is removed. There can be additional function in how the lid portion is removed from the container portion using pull-tab 336 when certain paint implements are stored in said paint container system, such as a brush and/or a roller. That is to say, the pull-tab 336 is located in the rear of said system's lid portion and opposite aperture 335 and gap 364 in order to more easily remove the lid portion from the container portion. This arrangement produces less chance of disengaging the roller's handle that is extending through aperture 335 from the slot or ledge 318 on the container portion's rim 324 at front side edge 323. Furthermore, when an implement, such as a brush is also being stored through the use of aperture 334 in the lid portion, pull-tab 336, located at the rear, is able to be pulled up and forward high enough to allow the user to grab the brush and secure it from underneath, or pull it completely from the aperture without causing the roller to dis-engage from its secure location at the front of the container portion's rim. The pull-tab can be in a variety of other locations around the lid portion's rim 332 and can be manipulated in numerous other ways in order to remove the lid portion from the container portion. The lid portion can further include notches 337 and 338 that can allow this configuration to fit securely over the container portion's ears 326 and 327. In various embodiments, the container portion can include a front side 322 including an inwardly extending portion that extends into the cavity that includes a slot or ledge 318 in the front side rim for holding a paint implement handle, such as a roller. Ears 326 and 327 that project outward from the sides of the container can be used to attach a bail. With the lid portion applied to the container portion, the container's bail remains fully functional and without any interference from the lid. Flexible strap 316 is attached to the rear side of the container body. The flexible strap having a first end attached to the rear side of the container body portion proximate a top of the rear side and a second end attached to the rear side of the container body portion proximate a bottom of the rear side. The flexible strap 316 can be stretched to provide space for a user's hand between the rear side of the container body and the strap.

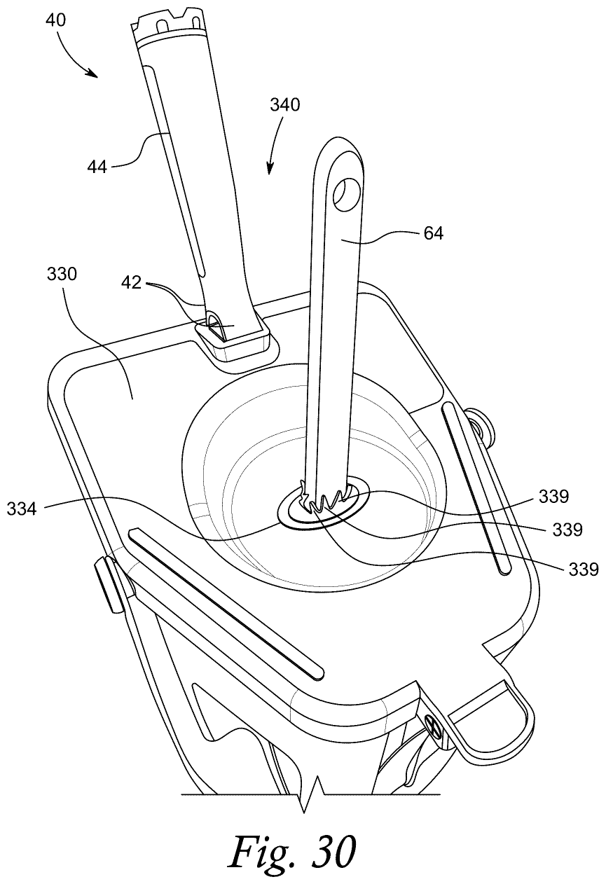

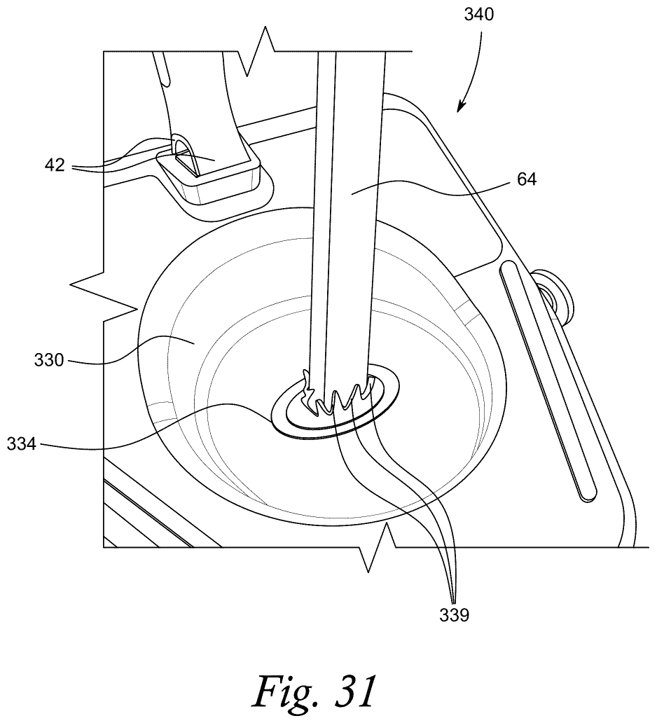

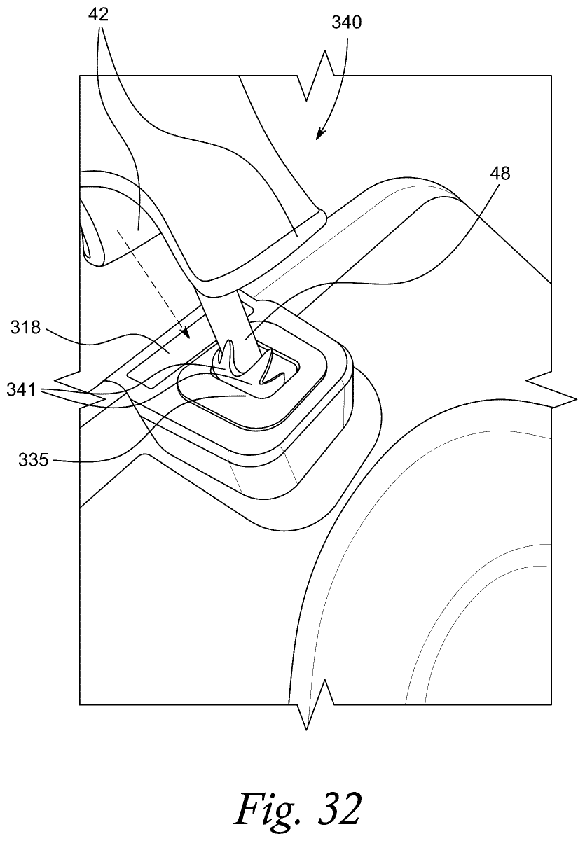

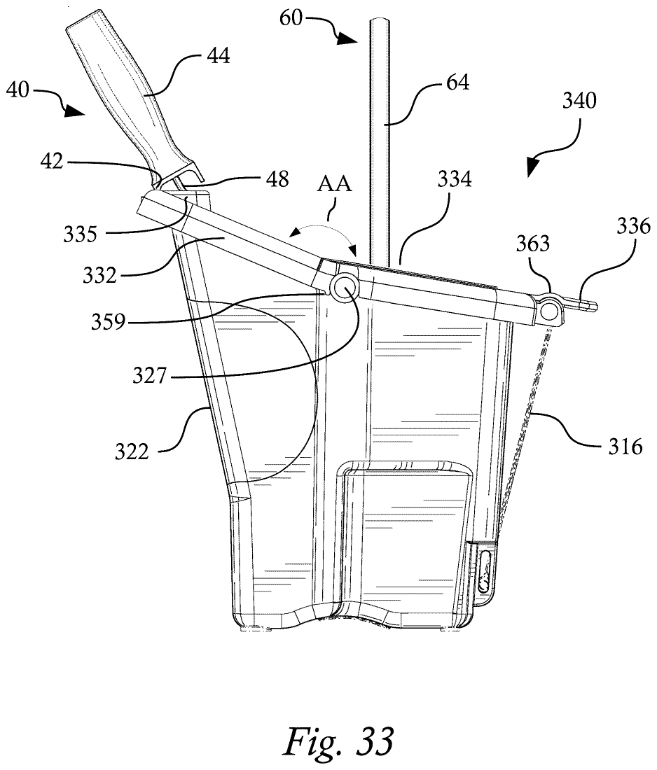

FIGS. 30-33 are various views of the container and applied lid of FIG. 27, and with a roller and brush stored inside the container, according to an illustrative embodiment. An exemplary paint container system 340 can include a sealed lid portion applied to a hand-held paint container portion. The lid portion can have a rim 332 that includes flanges that frictionally engages with the container's rim in certain locations including at the lid's rim obtuse angle AA located on the side edges that match the container's rim and effectively seals the lid to the container, while still making the lid easy to apply and remove. By way of non-limiting example, in various paint container systems the lid rim portion's angle AA and container rim portion's angle CC can be in a range between approximately 150 degrees and approximately 180 degrees. The lid's engagement with the container also allows for a liner to be used within the container body. Such liners are often used to assist in clean-up once the paint project is complete. Regardless of whether a liner is used or not, the lid creates an effective seal on the container.

The lid portion can have flexibly self-sealing apertures 334 and 335 to allow for optional paint implement storage, with the handles of the paint implement(s) extending upwards through the flexibly self-sealing apertures when the lid is applied to the container. These apertures also remain sealed if no paint implement is used. In various examples, but not all, the apertures can be parallel to the container portion's bottom when the lid portion is applied. When a paint implement, such as a roller 40 is used at aperture 335 the lid portion includes a gap 364 that allows the lid to be applied to and removed from the container, even while the implement remains in the container. Put another way, in various embodiments the lid's rim can have a gap, and the self-sealing aperture 335 can abut the gap. In this way, when the lid is applied to a container that has a roller in the container, the handle of the roller can pass through the gap and into the self-sealing aperture. When the sealed lid is removed later, the handle of the roller can exit the self-sealing aperture and pass through the gap in the lid's rim. Gap 364 can be adjacent to the self-sealing aperture 335, so that an implement extending through the self-sealing aperture can make a lateral transition into the gap without needing to be pulled out of the self-sealing aperture in a vertical direction. That is to say, when the self-sealing aperture is in an open conformation, the self-sealing aperture and the gap can form a continuous opening. When the rim of the lid meets the rim of the container, the gap 364 lies on top of the rim of the container so that the gap does not cause a loss of seal. That is to say, the gap does not extend beyond the rim of the lid. Paint roller 40 can include a handle 44 and flared end portions 42 that engages with a slot or ledge 318 in the front side rim of the container portion. The roller includes a shaft 48, that can be gripped by the fingers of the aperture 335, and the aperture 335 can form around the shaft of the roller.

Aperture 334 may be generally located near the center of the lid portion and also can form around paint implements, such as a handle of a brush 60. The aperture can accept a brush handle of various sizes and shapes, such as handle 64. Apertures 334, 335 can have flexible members such as fingers 339, 341 that can grip the handles of the paint implements and seal around them. The fingers 339, 341 can grip the handles of the implements while also allowing the handle(s) to slide up and down through the aperture opening in order to raise or lower the brush's bristles in the coating material, held within the container body portion, regardless of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position.

The lid can include a pull-tab 336 that in this particular configuration is designed to form over the container portion's vertical hand strap 316 at 363 located at the rear side of the lid. The pull-tab can be used to assist in removing the lid from the container by the use of an upwardly pull action that continues upward and towards the front of the container until the lid is removed. There can be additional function in how the lid portion is removed from the container portion using pull-tab 336 when certain paint implements are stored in said paint container system, such as a brush and/or a roller. That is to say, the pull-tab 336 is located in the rear of said system's lid portion and opposite aperture 335 and gap 364 in order to more easily remove the lid portion from the container portion. This arrangement produces less chance of disengaging the roller's handle that is extending through aperture 335 from the slot or ledge 318 on the container portion's rim 324 at front side edge 323. Furthermore, when an implement, such as a brush is also being stored through the use of aperture 334 in the lid portion, pull-tab 336, located at the rear, is able to be pulled up and forward high enough to allow the user to grab the brush and secure it from underneath, or pull it completely from the aperture without causing the roller to dis-engage from its secure location at the front of the container portion's rim. The pull-tab can be in a variety of other locations around the lid portion's rim 332 and can be manipulated in numerous other ways in order to remove the lid portion from the container portion. The lid portion can further include notches 337 and 338 that can allow this configuration to fit securely over the container portion's ears 326 and 327. In various embodiments the container portion includes a front side 322 including an inwardly extending portion that extends into the cavity that includes a slot or ledge in the front side rim for holding a paint roller 40 at its handle 44 and at its flared end portion 42. Ears 326 and 327 that project outward from the sides of the container can be used to attach a bail to the container. With the lid portion applied to the container portion, the container's bail remains fully functional and without any interference from the lid. Flexible strap 316 is attached to the rear side of the container body. The flexible strap having a first end attached to the rear side of the container body portion proximate a top of the rear side and a second end attached to the rear side of the container body portion proximate a bottom of the rear side. The flexible strap 316 can be stretched to provide space for a user's hand between the rear side of the container body and the strap.

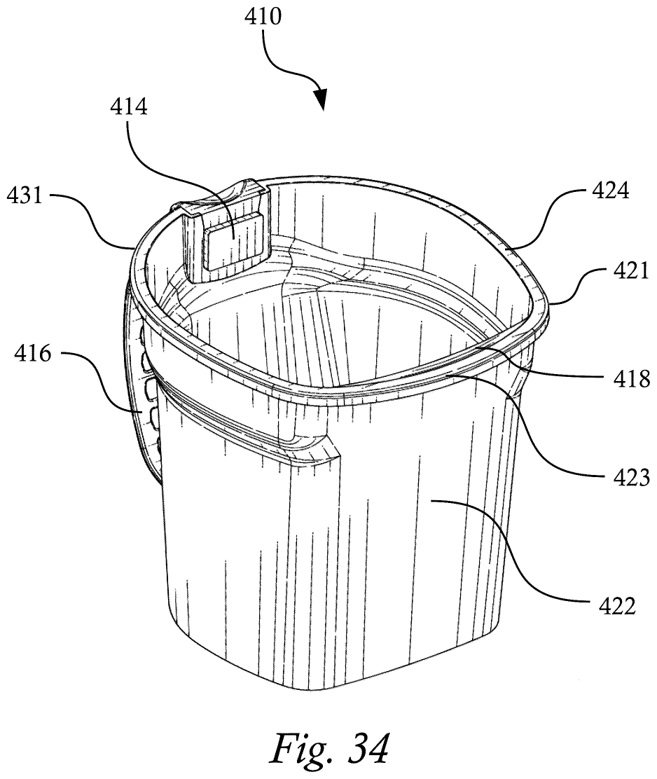

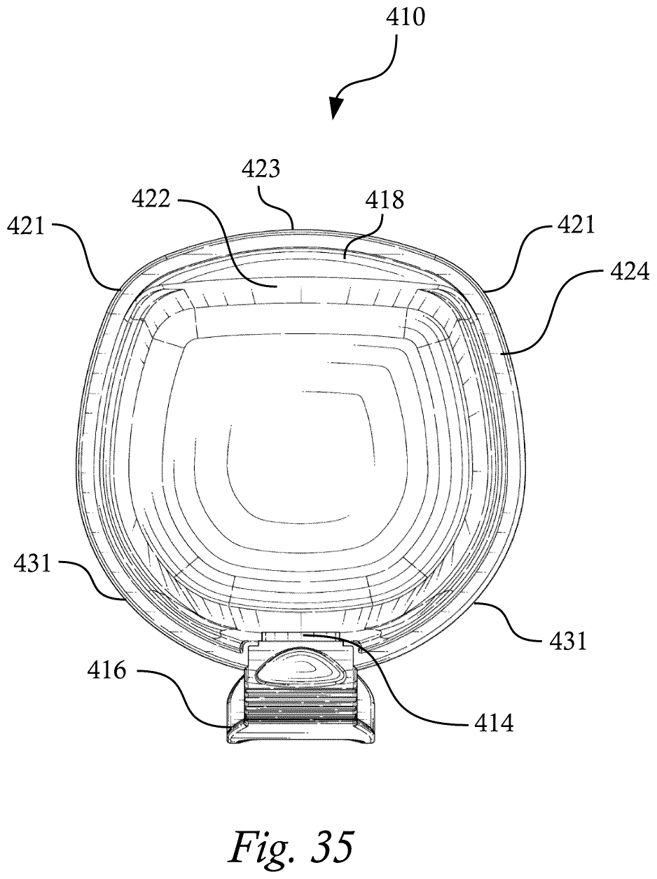

FIGS. 34 and 35 are a front perspective view and a top view of another exemplary container, according to an illustrative embodiment. The container 410 can include a container body having a rim 424 with radiused corners 421 that pitches upward from front side edge 423 that leads to a rounded edge 431 at the rear side of the container. In various embodiments, no side of the container's rim is parallel with any other. The container can include a front, a rear, a right side, a left side, and a bottom that define a cavity for receiving a coating material. The right side and left side can each include an inwardly extending portion that extends into the cavity, A rear side that can include an inwardly extending portion that extends into the cavity that can include a magnetic means 414 for detachably holding a paint brush to the interior of the container. A front side 422 can include an inwardly extending portion that extends into the cavity, and can include a slot or ledge 418 in the front side rim. A flexible strap 416 can be attached to the rear side of the container body. The flexible strap can have a first end attached to the rear side of the container body proximate a top of the rear side and a second end attached to the rear side of the container body proximate a bottom of the rear side. The flexible strap 416 can be stretched to provide space for a user's hand between the rear side of the container body and the strap.

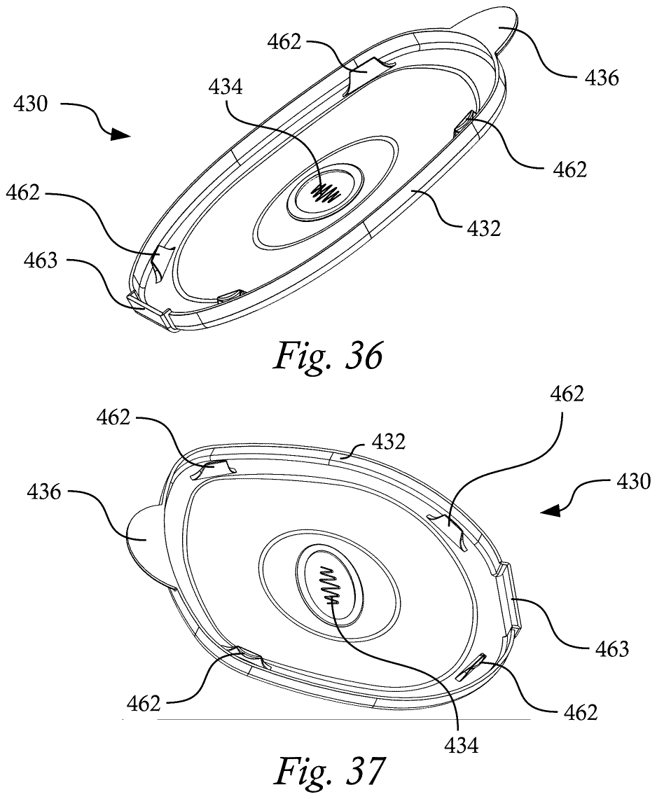

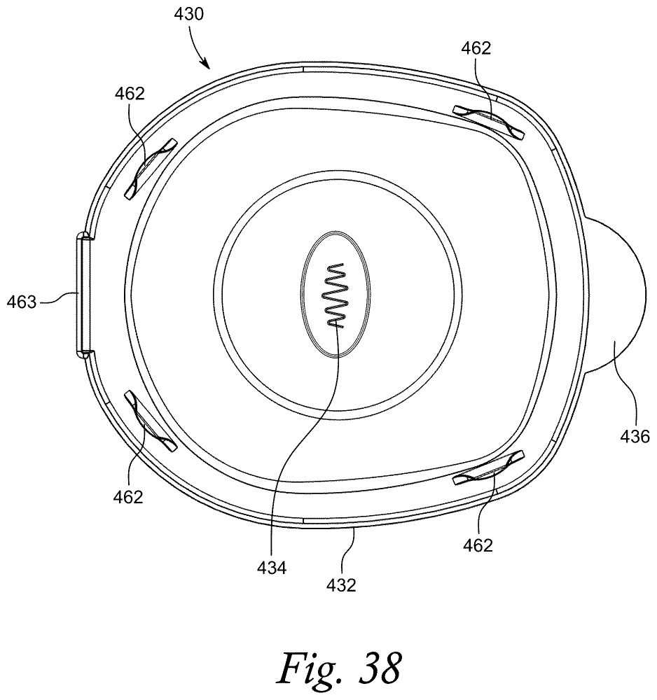

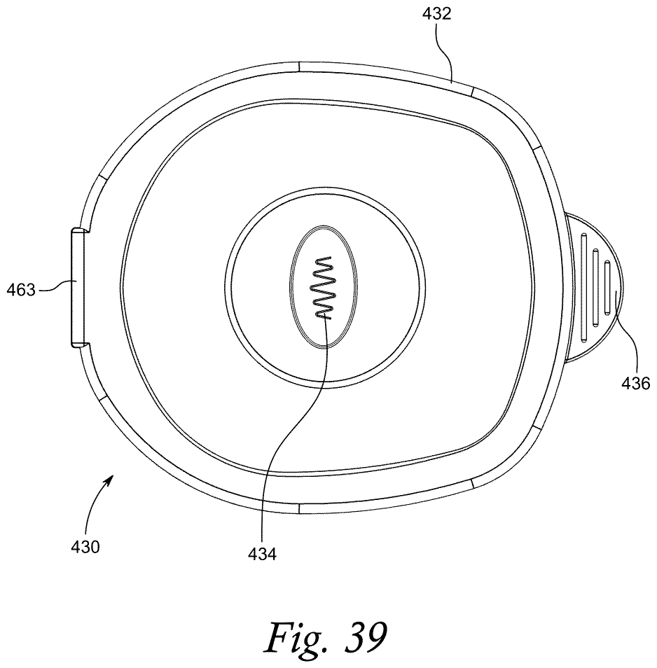

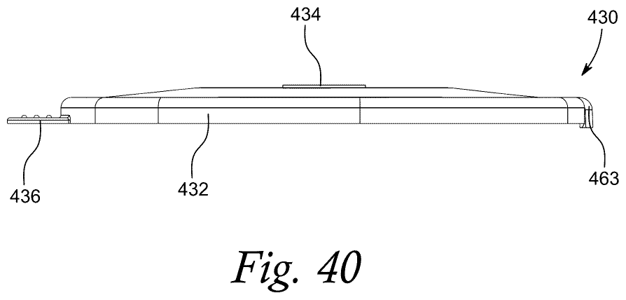

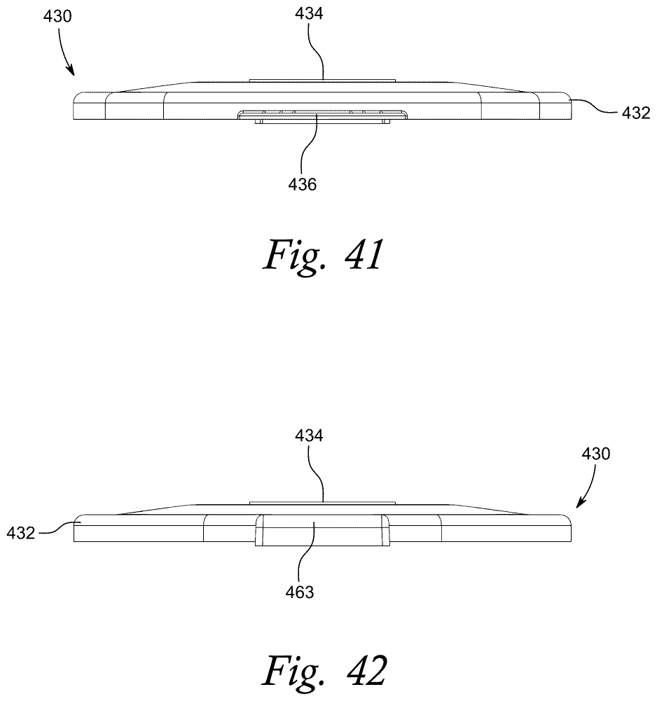

FIGS. 36-42 are various views of an exemplary lid adapted for use on the container of FIG. 34, according to an illustrative embodiment. The exemplary lid 430 can have a rim 432 that can frictionally engage with the container portion's rim. Just inside the rim 432, the lid can have feet 462 that extend downwards from the bottom of the lid. Feet 462 can be spaced a distance from the lid's rim 432 to accommodate the rim of the container between the lid's rim and the feet 462. Feet 462 can have a contact surface that can frictionally engages with a paint container's interior walls. In various embodiments, feet 462 can work together with rim 432 to pinch the rim of the container and effectively seal the lid to the container, while still making the lid easy to apply and remove. Such feet can be in various other configurations and placed at other locations on the underside of the lid, including at the lid's rim 432 to achieve a secured seal to the container. The lid also allows for a paint container liner to be used within the container body. Such liners are often used to assist in clean-up once the paint project is complete. Regardless of whether a liner is used or not, the lid creates an effective seal on the container.

The lid can include flexibly self-sealing aperture 434 to allow for optional paint implement storage. The aperture also remains sealed if no paint implement is used. When a paint implement, such as a brush is used, aperture 434 allows the brush handle to slide up and down through the aperture opening in order to raise or lower the brush's bristles in the coating material, held within the container body portion, regardless of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position.

The lid can include a pull-tab 436 that in this configuration is located at the front side of the lid. The lid is further designed to form over the container's vertical hand strap 463 at the rear of the container. The pull-tab can be used to assist in removing the lid from the container by means of an upwardly pull action that continues upward and towards the back side of the container until the lid is removed. A pull-tab can be in a variety of locations around the lid's rim 432 and can be manipulated in numerous other ways in order to remove the lid from the container.

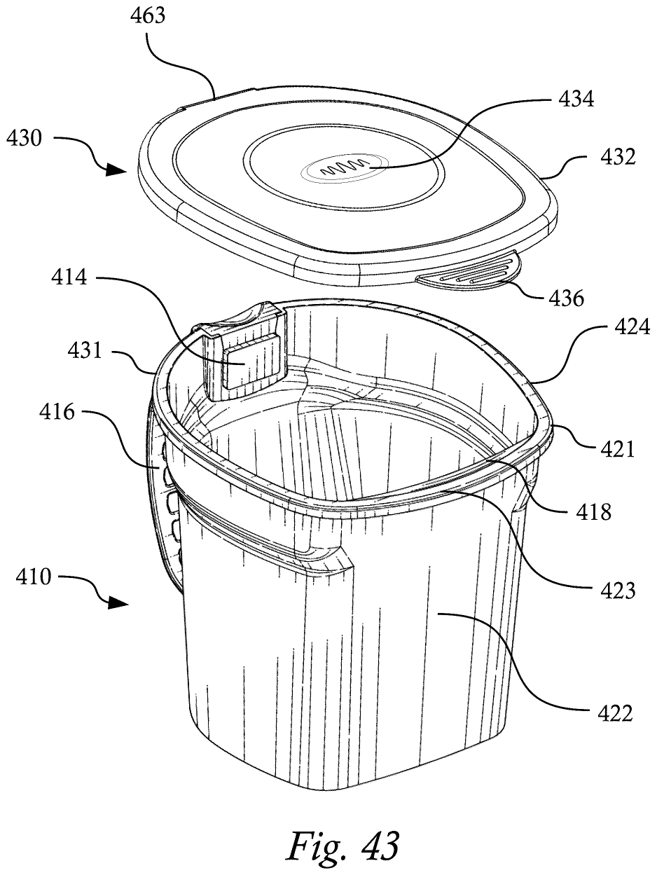

FIG. 43 is a front perspective view of the container of FIG. 34 with the lid of FIG. 36 positioned above the container, according to an illustrative embodiment. The lid portion 430 can have a rim 432 that frictionally engages with the rim of the container 410. Just inside the rim 432, the lid can have feet 462 that extend downwards from the bottom of the lid. Feet 462 can be spaced a distance from the lid's rim to accommodate the rim of the container between the lid's rim and the feet 462. Feet 462 can have a contact surface that can frictionally engage with a paint container's interior walls. In various embodiments, feet 462 can work together with rim 432 to pinch the rim of the container and effectively seal the lid to the container, while still making the lid easy to apply and remove. Such areas of engagement can be in various other configurations and placed at other locations on the underside of the lid, including at the lid's rim 432 to achieve a secured seal to the container portion.

The lid portion can include flexibly self-sealing aperture 434 to allow for optional paint implement storage. The aperture can also remain sealed if no paint implement is used. When a paint implement, such as a brush is used, aperture 434 can allow the brush handle to slide up and down through the aperture opening in order to raise or lower the brush's bristles in the coating material, held within the container body portion, regardless of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position.

The lid portion can further include a pull-tab 436 that in this particular configuration is located at the front side of the lid. At the rear side of the lid portion it is further designed at 463 to form over the container portion's vertical hand strap 416. The pull-tab can be used to assist in removing the lid from the container by means of an upwardly pull action that continues upward and towards the back side of the container portion until the lid portion is removed. A pull-tab can be in a variety of locations around the lid portion's rim 432 and can be manipulated in numerous other ways in order to remove the lid portion from the container portion.

The lid portion can have a rim 432 that can frictionally engage with the container body portion's rim to effectively seal the lid portion to the container portion, while making it easy to apply and remove, and still allowing for a liner to be used within the container body portion. Such liners are often used to assist in clean-up once the paint project is complete. Regardless of whether a liner is used or not, the lid portion can create an effective seal on the container portion. In this embodiment the container portion 410 includes a container body having a rim 424 with radiused corners 421 and is pitched upward beginning at the front side edge 423 and leads to a curved edge 431 at the rear side. In various embodiments, no side of the container portion's rim or lid portion's rim are parallel with any other side. The container portion can include a container body having a front, a rear, a right side, a left side, and a bottom that define a cavity for receiving a coating material. The container portion's front side 422 can include an inwardly extending portion that extends into the cavity, and can include a slot or ledge 418 in the front side rim. A flexible strap 416 can be attached to the rear side of the container body. The flexible strap can have a first end attached to the rear side of the container body portion proximate a top of the rear side and a second end attached to the rear side of the container body portion proximate a bottom of the rear side. The flexible strap 416 can be stretched to provide space for a user's hand between the rear side of the container body and the strap.

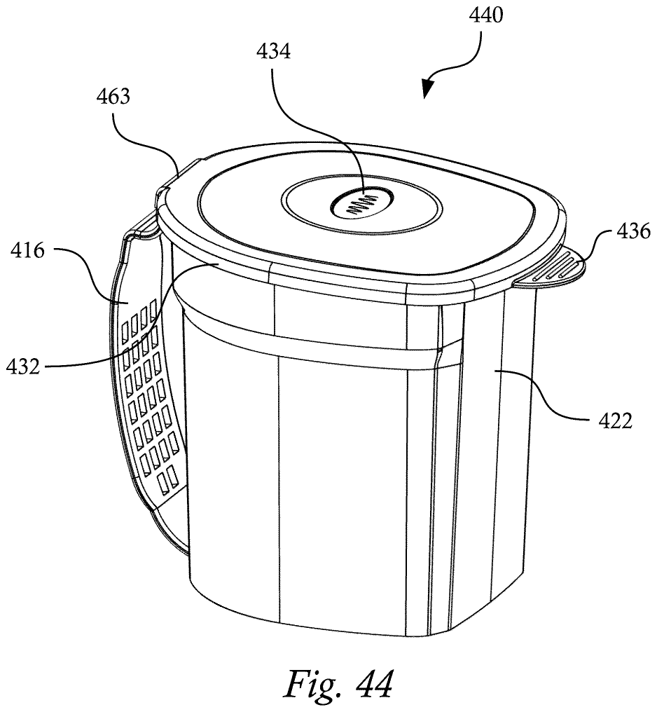

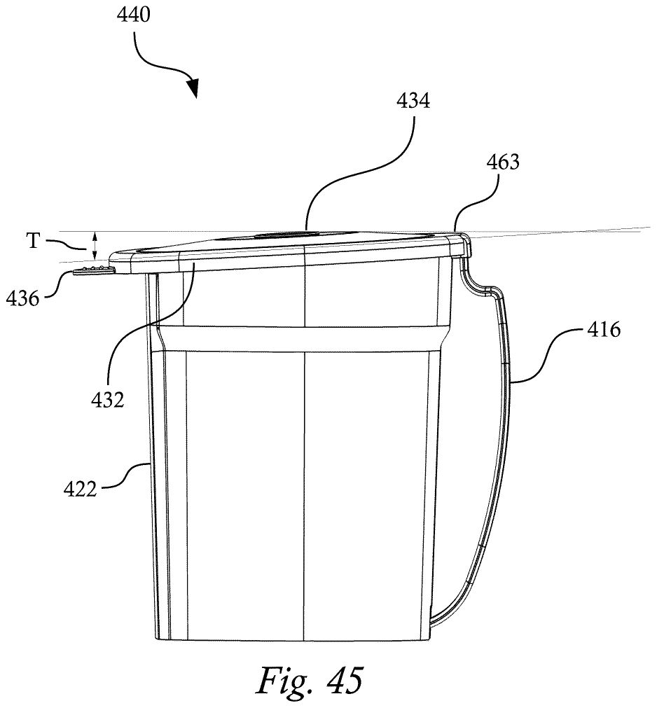

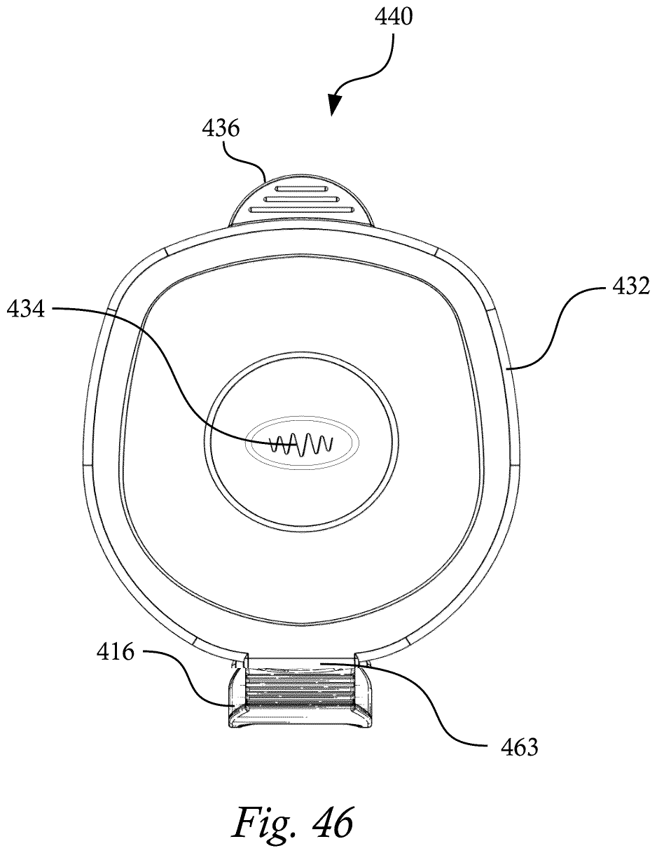

FIGS. 44-46 are various views of the container of FIG. 34 with the lid of FIG. 36 ap-plied onto the container to seal the contents, according to an illustrative embodiment. An exemplary paint container system 440 can include a sealed lid portion applied to a hand-held paint container portion. The lid portion can have a rim 432 that can frictionally engage with the container portion's rim. Just inside the rim 432, the lid can have feet that can extend downward from the bottom of the lid. The feet can be spaced a distance from the lid's rim to accommodate the rim of the container between the lid's rim and the feet. Feet can have a contact surface that can frictionally engage with the paint container's interior walls. The feet can work together with the rim 432 to pinch the rim of the container and effectively seal the lid portion to the container portion, while still making the lid easy to apply and remove from the container. Such areas of engagement between the lid and container can be in various other configurations and placed at other locations on the underside of the lid, including at the lid's rim to achieve a secured seal to the container portion.

The lid portion, when attached to the container portion, can further allow for a liner to be used within the container portion's body. Such liners are often used to assist in clean-up once the paint project is complete. Regardless of whether a liner is used or not, the lid portion creates an effective seal on the container portion. The rim of the container portion can slope at angle T of between approximately 1 degree and approximately 15 degrees measured from the container's back side edge where handle 416 is located and terminating at the container's front side edge 422, however, in various embodiments angle T can vary. The lid portion can have flexibly self-sealing aperture 434. This aperture can also remain sealed if no paint implement is used. Aperture 434 may be generally located near the center of the lid and can form around a paint implement, such as a brush, at its handle, and in particular, the aperture accepts a brush handle of various sizes and shapes. Aperture 434 can also allow the brush handle to slide up and down through the aperture opening in order to raise or lower the brush's bristles in the coating material, held within the container body portion, regardless of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position. In various embodiments, the location of aperture 434 can vary.

The lid portion can further include a pull-tab 436 that in this particular configuration is located at the front side of the lid. At the rear side of the lid portion it is further designed at 463 to form over the container portion's vertical hand strap 416. The pull-tab can be used to assist in removing the lid from the container using an upwardly pull action that continues upward and towards the back of the container until the lid is removed. A pull-tab can be in a variety of locations around the rim 432 and can be manipulated in numerous other ways in order to remove the lid from the container.

In various embodiments, the container portion 410 can include a container body having a rim 432 with radiused corners and is pitched upward beginning at the front side edge and leads to a curved edge at the rear side. In various embodiments, no side of the container portion's rim or lid portion's rim are parallel with any other side. The container portion can include a container body having a front, a rear, a right side, a left side, and a bottom that define a cavity for receiving a coating material. The container portion's front side 422 can include an inwardly extending portion that extends into the cavity, and can include a slot or ledge in the front side rim. A flexible strap 416 can be attached to the rear side of the container body. The flexible strap can have a first end attached to the rear side of the container body portion proximate a top of the rear side and a second end attached to the rear side of the container body portion proximate a bottom of the rear side. The flexible strap 416 can be stretched to provide space for a user's hand between the rear side of the container body and the strap.

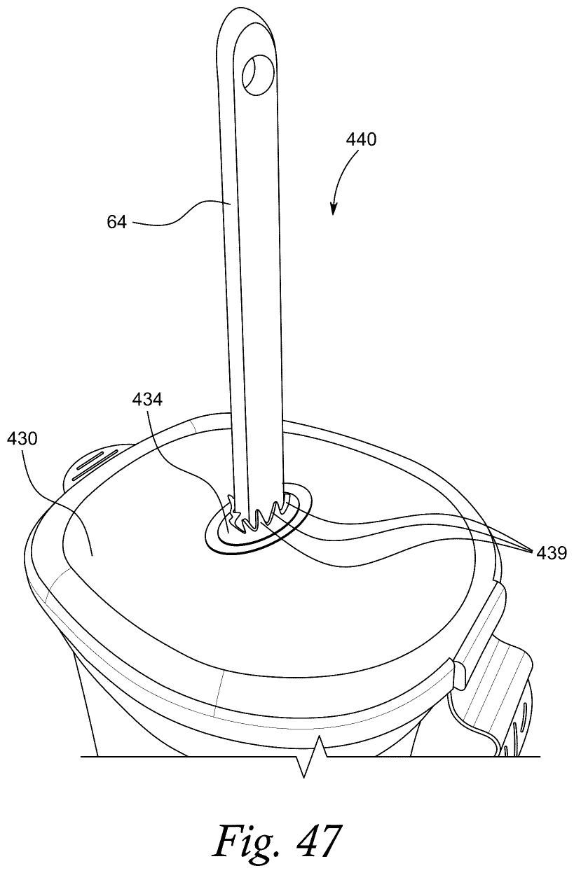

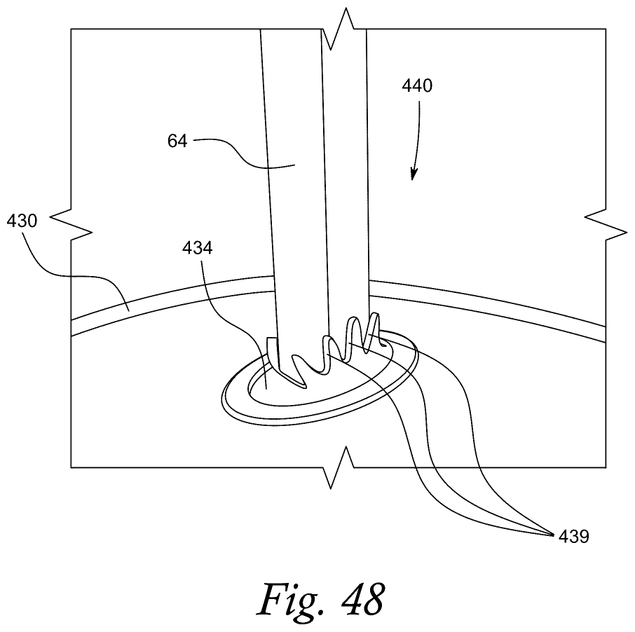

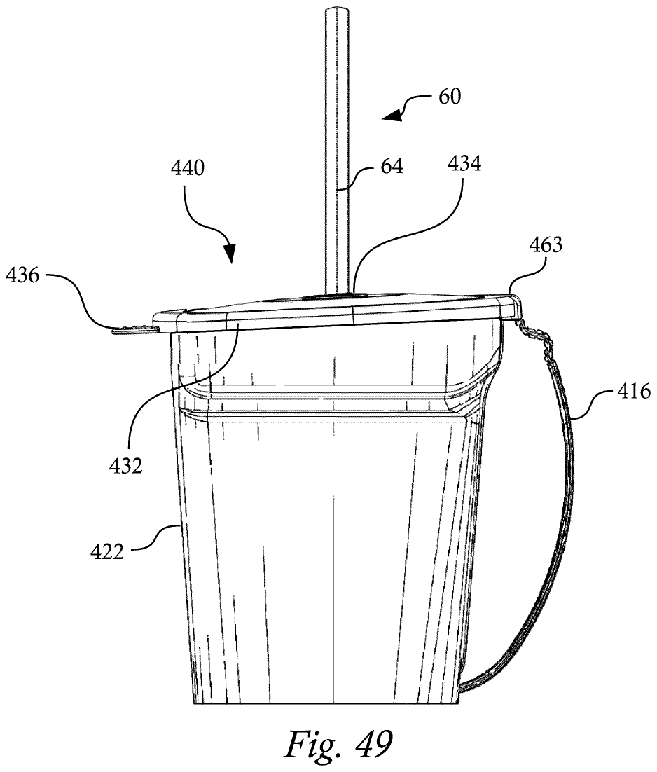

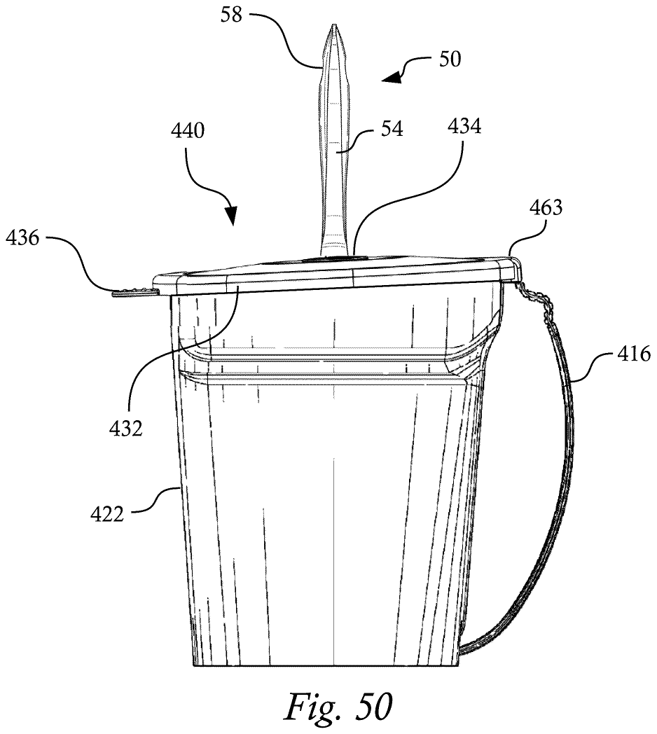

FIGS. 47-50 are various views of the container and applied lid of FIG. 44, and with a brush stored inside the container, according to an illustrative embodiment. An exemplary paint container system 440 can include a sealed lid portion applied to a hand-held paint container portion. The lid portion can have a rim 432 that can frictionally engage with the container portion's rim. Just inside the rim 432, the lid can have feet that can extend downwards from the bottom of the lid. The feet can be spaced a distance from the lid's rim to accommodate the rim of the container between the lid's rim and the feet. Feet can have a contact surface that can frictionally engage with the paint container's interior walls. The feet can work together with the rim 432 to pinch the rim of the container and effectively seals the lid portion to the container portion, while still making the lid easy to apply and remove from the container. Such areas of engagement between the lid and container can be in various other configurations and placed at other locations on the underside of the lid, including at the lid's rim to achieve a secured seal to the container portion.

The lid portion, when attached to the container portion, further allows for a liner to be used within the container portion's body. Such liners are often used to assist in clean-up once the paint project is complete. Regardless of whether a liner is used or not, the lid portion creates an effective seal on the container portion. The lid can have flexibly self-sealing aperture 434. This aperture also remains sealed if no paint implement is used. Aperture 434 may be generally located near the center of the lid and can form around a paint implement, such as a brush 50 or 60 at handle 54 or 64 and specifically, the aperture can accept a brush handle of various sizes and shapes. Aperture 434 can have flexible members such as fingers 439 that can grip the handles of the paint implements and seal around them. The fingers can grip and seal around the handles of the implements while also allowing the handle to slide up and down within the aperture. Aperture 434 can allow the brush handle to slide up and down through the aperture opening in order to raise or lower the brush's bristles in the coating material, held within the container body portion, regardless of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position. In various embodiments. In various embodiments, the location of aperture 434 can vary.

The lid portion can further include a pull-tab 436 that in this particular configuration is located at the front side of the lid. At the rear side of the lid portion it is further designed at 463 to form over the container portion's vertical hand strap 416. The pull-tab can be used to assist in removing the lid from the container using an upwardly pull action that continues upward and towards the back of the container until the lid is removed. A pull-tab can be in a variety of locations around the rim 432 and can be manipulated in numerous other ways in order to remove the lid from the container.

In various embodiments the container portion 410 can include a container body having a rim 432 with radiused corners and is pitched upward beginning at the front side edge and leads to a curved edge at the rear side. In various embodiments, no side of the container portion's rim or lid portion's rim are parallel with any other side. The container portion can include a container body having a front, a rear, a right side, a left side, and a bottom that define a cavity for receiving a coating material. The container portion's front side 422 can include an inwardly extending portion that extends into the cavity, and can include a slot or ledge in the front side rim. A flexible strap 416 can be attached to the rear side of the container body. The flexible strap can have a first end attached to the rear side of the container body portion proximate a top of the rear side and a second end attached to the rear side of the container body portion proximate a bottom of the rear side. The flexible strap 416 can be stretched to provide space for a user's hand between the rear side of the container body and the strap.

FIGS. 51-53 are various views of additional exemplary containers 510, 610, and 710 for holding a coating material. These containers can include a container body having a rim, a front, a rear, a right side, a left side, and a bottom that define a cavity for receiving a coating material. Each container can have a front and rear side that includes an inwardly extending portion that extends into the cavity that includes various apparatuses for holding painting implements, such as a brush and/or a roller within the container. These containers can include an inwardly extending portion that can extend into the cavity and can includes a plurality of inner surface scraper regions and projecting therefrom for scraping paint off from a painting apparatus, such as a roller 40. These containers can include a rim for holding a roller handle 524, 624 and 724 to the interior of the container. Various containers can have a handle 526, 644, 744 for holding/carrying the container. It should be clear that various lids for various containers are possible. Various containers such as containers 526, 644, and 744 can all have corresponding lids that can engage with the rim of the container to seal the contents of the container. Various lids can have self-sealing apertures in the lid that can accommodate, and seal around, handles of various implements.

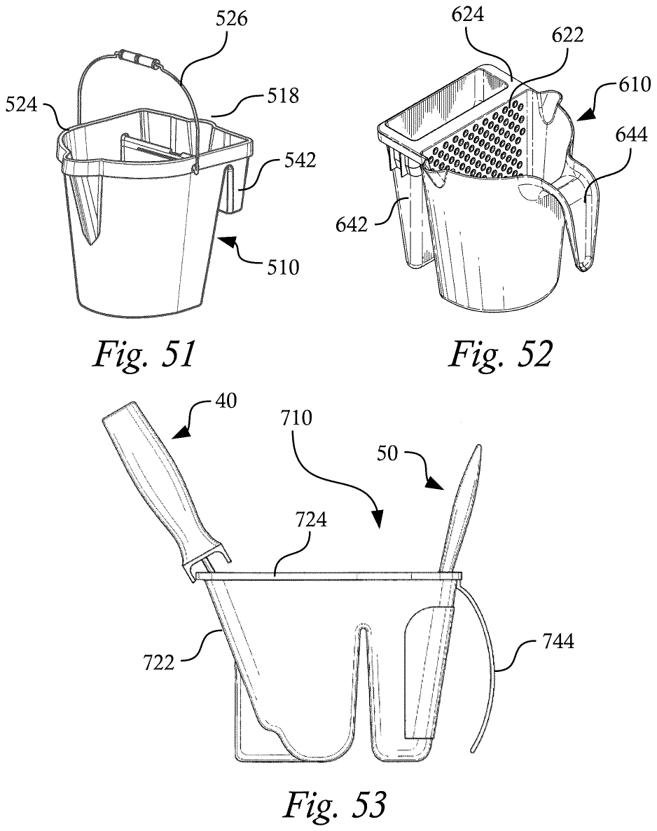

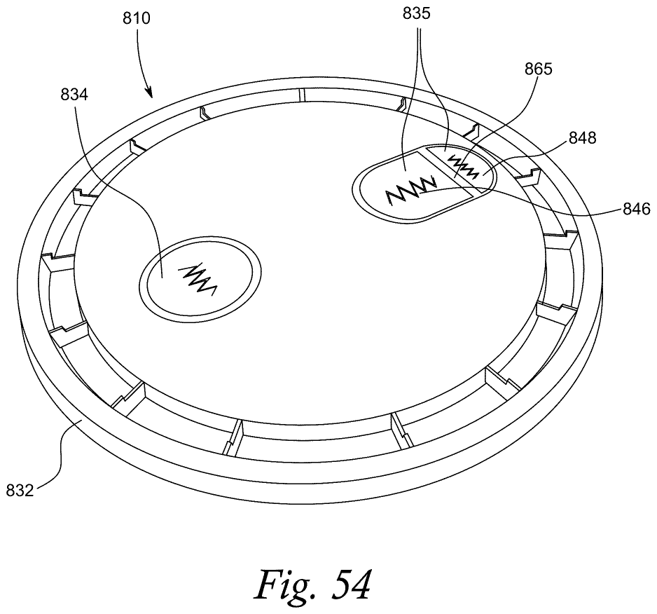

FIG. 54 is a perspective view of an exemplary lid adapted for use on a round container such as a standard 5-gallon container, according to an illustrative embodiment. Lid 810 can have a rim 832 that can frictionally engage with a round paint container rim and can effectively seal the lid to the container, while still making the lid easy to apply and remove. The lid can include flexibly self-sealing apertures 834 and 835 to allow for optional paint implement storage. In various embodiments, apertures 834 and 835 may be located away from the center of the lid.

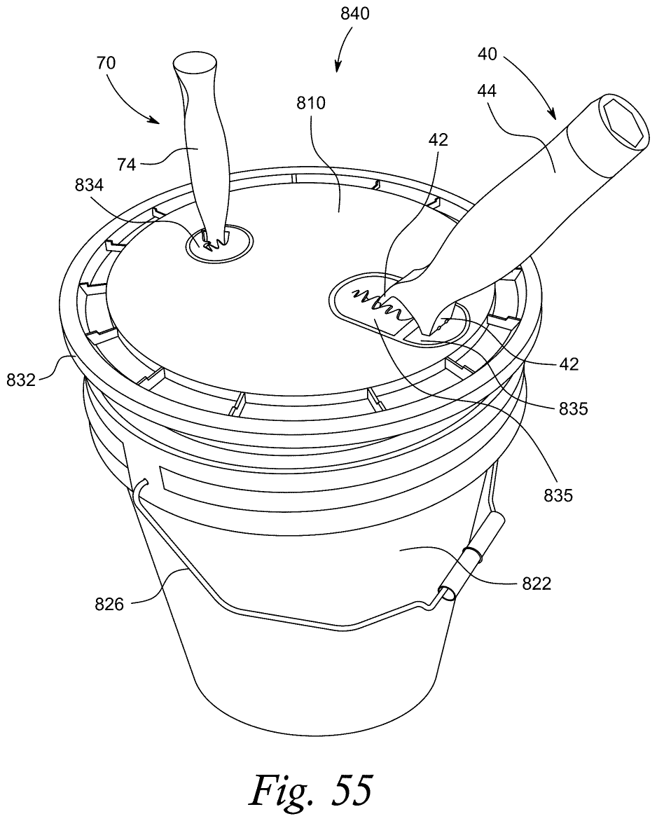

FIG. 55 is a top perspective view of the exemplary lid of FIG. 54 applied to a round container such as a 5-gallon container to seal the contents, and with a roller and brush stored inside the container, according to an illustrative embodiment. Paint container system 840 can have a lid portion 810 with a rim 832 that can frictionally engage with the container portion 822 at the container's rim and effectively seal the lid to the container while still allowing the lid to be easy to apply and remove. The lid portion can have flexibly self-sealing apertures 834 and 835. Aperture 834 is generally not located at the center of the lid, and can form a seal around a handle 74 or a paint implement such as paint brush 70. The aperture 834 can accommodate various sizes and shapes of brush handles. Aperture 835 is generally not located at the center of the lid, and can form a seal around the handle of a paint implement such as roller 40. The apertures can allow the lid to be applied to the container while the paint implements remain in the container. The apertures can remain sealed if no paint implements are used.

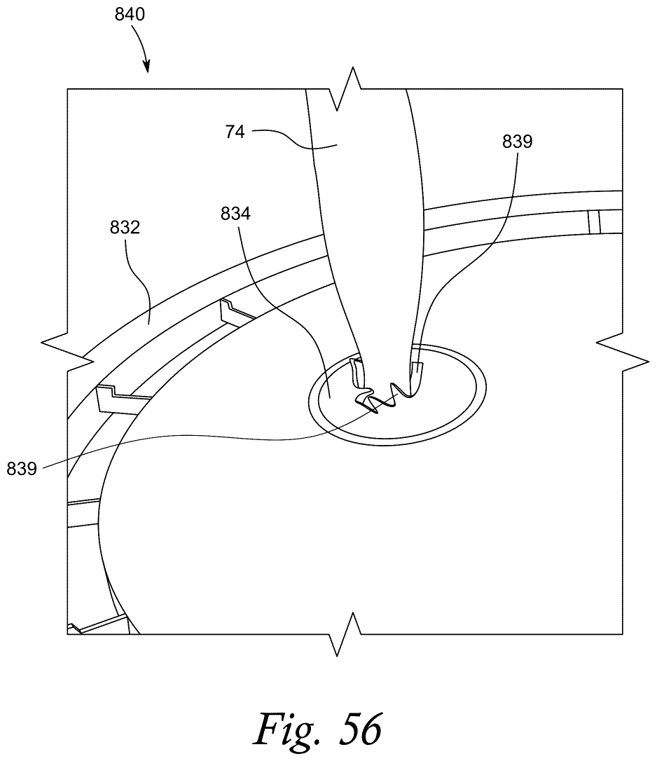

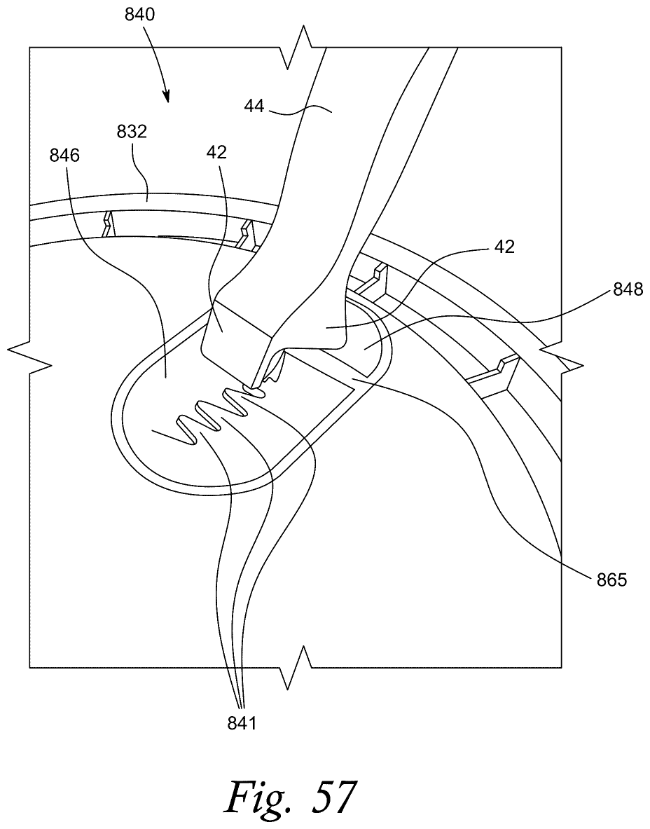

FIG. 56 is a detailed view of the brush aperture of FIG. 54 with a brush handle extending through the aperture, according to an illustrative embodiment, and FIG. 57 is a detailed view of the roller aperture of FIG. 54 with a roller handle extending through the aperture, according to an illustrative embodiment. The lid portion 810 can have a rim 832 that frictionally engages with the rim of the container portion and effectively seals the lid to the container, while still making the lid easy to apply and remove. The lid portion can have flexibly self-sealing apertures 834 and 835. Aperture 834 can form a seal around an implement, such as handle 74 of brush 70. The brush aperture 834 can accommodate various sizes and shapes of brush handles.

Aperture 834 can have flexible members such as fingers 839 that can grip the handles of the paint implements and seal around them. The fingers can grip and seal around the handles of the implements while also allowing the handle to slide up and down within the aperture. Aperture 834 can allow the handle to slide up and down through the aperture opening in order to raise or lower the implement in the coating material, held within the container body portion, regardless of what the level of said coating material might be. That is to say, the aperture seals tightly around the handle of the implement, and can hold the handle of the implement at a preferred height/depth within the container, with the heigh/depth chosen by a user by pulling or pushing the handle into the desired position. The fingers of the self-sealing aperture can grip and hold the brush handle in the desired position. In various embodiments. In various embodiments, the location of aperture 834 can vary.

Roller aperture 835 can be adapted to seal around, and support, a roller 40. Roller 40 can include a handle 44 and flared end portions 42. In various embodiments, a roller aperture 835 can be separated into two regions by a rigid support 865 that can be a portion of the lid 810. The roller aperture 835 can have two aperture openings 846 and 848 on either side of the rigid support 865, and the rigid support may be adapted to support the flared end 42 of a roller handle 44. Flared end portion 42 can hook to the rigid support 865 of the lid portion to prevent the roller from sinking into the paint container. Aperture opening 848 can engage and seal with the flared portion 42 of the roller when the flared portion is hooked around the rigid support 865. At the same time, the shaft of the roller can extend through aperture opening 846, and the fingers of aperture opening 846 can seal around the shaft of the roller. Aperture 835 can also have flexible members such as fingers 841 located at aperture openings 846 and 848 that grips and seals the paint implement yet allows the handle of the implement to slide up and down through the aperture opening in order to raise or lower the implement within the container body portion, regardless of what the level of said coating material might be. Aperture opening 846 may accommodate the roller handle 44 for example and also be able to form and seal around the roller's shaft 48. The roller handle 44 can pass through the aperture opening 846, and then the flared portion of the roller handle can hook over the rigid support 865, and flexibly sealable aperture opening 848 can seal around the flared portion 42. The two aperture openings 848 and 848 can work together to seal around a roller that is supported on the rigid support 865 between the two aperture openings. All apertures remain sealed if no paint implement is used.

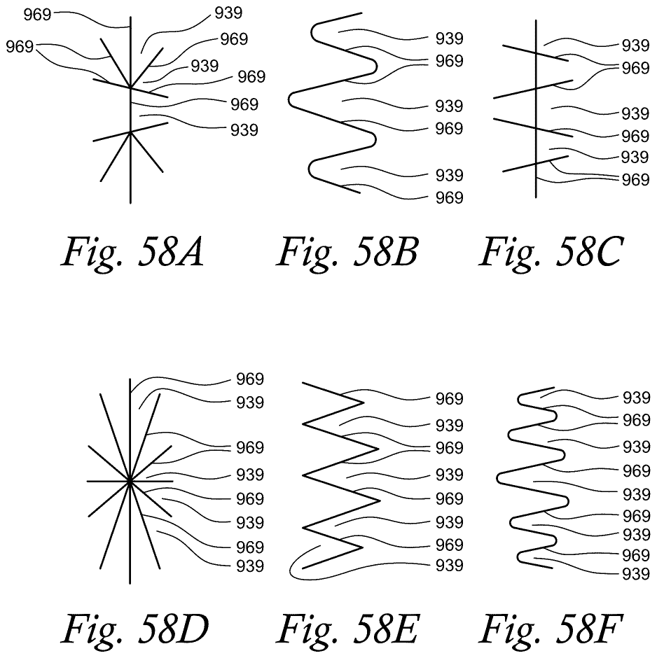

FIGS. 58A-58F are diagrams of various exemplary flexibly self-sealing aperture opening designs, according to an illustrative embodiment. Various flexibly self-sealing apertures can have fingers 939 that can be separated by slits 969. Various apertures can stretch open to accommodate the handles of paint implements. Various designs of fingers 939 can seal around the handles of various paint implements that pass through the apertures.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bot-tom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Note also, as used herein the terms “process” and/or “processor” should be taken broadly to include a variety of electronic hardware and/or software based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A lid for a paint pail adapted to engage with a paint pail to seal the contents of the paint pail, the lid comprising:
a rim adapted to engage with the rim of the paint pail; and
at least one self-sealing aperture adapted to allow a paint implement to extend through the lid while the lid seals the paint pail.
